(19) United States
(12) Patent Application Publication
(10) Pub. No.: US 2012/0128837 A1
(43) Pub. Date: May 24, 2012

(54) SOLVENT EXTRACTED HIGH LYSINE CORN

(75) Inventor: Paul J. McWilliams, Racine, WI (US)

(73) Assignee: RENESSEN LLC, St. Louis, MO (US)

(21) Appl. No.: 12/995,888

(22) PCT Filed: Jun. 2, 2009
(86) PCT No.: PCT/US09/45907

§ 371 Date: Jan. 31, 2011

(30) Foreign Application Priority Data
Jun. 6, 2008 (US) 61/059515

(51) Int. Cl. A23K 1/14; A23D 9/04; A23D 9/007

(52) U.S. Cl. 426/231; 426/601; 426/430

(57) ABSTRACT

An improved extracted corn comprising from about 0.6 to about 2.8 percent by weight (on an anhydrous basis). The composition has a nutritional profile advantageous for use as an animal feed ingredient. Also provided are processes for the preparation of the extracted corn composition; feed rations incorporating the extracted corn composition; and methods for the preparation of such feed rations.

### FIELD OF THE INVENTION

The present invention generally relates to a solvent extracted corn composition (sometimes referred to as extracted corn meal) having a lysine concentration of between about 0.6 percent by weight (“wt %”) and about 2.8 wt % and a nutritional profile advantageous for use as an animal feed ingredient; a process for the preparation of the extracted corn composition; feed rations incorporating the extracted corn composition; and to methods for the preparation of such feed rations.

### BACKGROUND OF THE INVENTION

Corn, Zea mays, is grown for many reasons including its use in food and industrial applications. Corn oil and corn meal are two of many useful products derived from corn.

Commercial processing plants utilizing conventional methods for extracting corn oil from whole corn kernels first separate the corn seed into its component parts (pericarp, tip cap, germ and endosperm) by wet or dry milling. Oil is then extracted from the corn germ fraction either by pressing the germ to remove the oil or by flaking the germ and extracting the oil with a solvent.

In U.S. Pat. No. 6,388,110, Ulrich et al. describe a process for extracting corn oil from corn kernels having a total oil content in excess of 8 weight percent. The process comprises flaking the kernels and solvent extraction of the oil from the flaked kernels.

In WO 05/108533, Van Houten, et al. disclose a corn oil extraction process wherein corn kernels having a moisture content of about 8 wt. % to about 22 wt. % are fractionated to produce a high oil corn fraction and a low oil corn fraction. Corn oil is solvent extracted from the high oil fraction, leaving a solvent extracted high oil fraction product which, in some embodiments, may then be used as an ethanol fermentation feedstock or, in other embodiments, combined with other ingredients and used as a feed or food product for swine, poultry, cattle, pets or human.

Although the process described in WO 05/108533 is useful for the preparation of corn oil and solvent extracted corn, a need exists for a process that has improved oil extraction efficiency and a process that generates solvent extracted corn having high lysine concentration.

### SUMMARY OF THE INVENTION

The present invention provides a solvent extracted corn composition having high lysine concentration and methods for formulating animal feed rations from the solvent extracted corn composition.

One aspect of the present invention is directed to an extracted high lysine corn fraction composition prepared from high lysine corn kernels comprising starch, protein, oil, and on an anhydrous basis, from about 0.6 to about 2.8 weight percent total lysine.

Another aspect is directed to a process for preparing an extracted high lysine corn fraction from high lysine corn kernels. The process comprises fractionating corn kernels comprising protein, oil and from about 3,000 parts per million to about 8,000 parts per million total lysine on an anhydrous basis into a high lysine fraction and a low lysine fraction, the high lysine fraction having a lysine content greater than the corn kernels and the low lysine fraction having an lysine content less than the corn kernels. The high lysine fraction is separated from the low lysine fraction and the high lysine fraction is heat and pressure treated with steam in an expander to produce expandettes. Oil is extracted from the expandettes with at least one solvent to prepare the extracted high lysine corn fraction.

Yet another aspect is directed to a method for formulating an animal food ration. The method comprises determining the lysine requirements of the animal and identifying a plurality of natural and/or synthetic feed ingredients and the available total lysine of each of the ingredients wherein one of the ingredients is a corn portion having a total lysine concentration of from about 0.6 to about 2.8 percent by weight on an anhydrous basis. The ration is formulated from the identified ingredients to meet the determined lysine requirement of the animal.

Other objects and features will be in part apparent and in part pointed out hereinafter.

### BRIEF DESCRIPTION OF THE DRAWINGS

Corresponding reference characters indicate corresponding parts throughout the drawings.

FIG. 1 is a schematic flow chart of a prior art process for the separation of corn germ and endosperm.

FIG. 2 is a schematic flow chart of one embodiment of the present invention.

FIG. 3 is a schematic flow chart of one embodiment of a two stage fractionation process of the present invention.

FIG. 4 is a schematic flow chart of one embodiment of a corn cracking process of the present invention.

FIG. 5 is a schematic flow chart of an alternative embodiment of the present invention.

### DETAILED DESCRIPTION OF THE INVENTION

The present invention is directed to a solvent extracted corn meal composition having elevated lysine, tryptophan and protein concentration, and low oil concentration. The present invention is also directed to processes for the preparation of the composition and animal feeds containing the composition.

In general, the process of the present invention comprises processing high lysine corn kernels in a fractionation step, an expansion step, and a solvent extraction step. In the fractionation step, the corn kernels are fractionated into portions comprising a high oil fraction (“HOF”) and a low oil fraction (“LOF”) as described, for example, in WO 05/108533. For purposes of the present invention, the HOF is also termed the high lysine fraction (“HLF”), the HLF having a lysine content greater than the corn kernels. The LOF is also termed the low lysine fraction (“LLF”), the LLF having a lysine content less than the corn kernels. The HLF is then treated with steam in an expander to produce an expandette and the corn oil is then solvent extracted from the expandettes to generate a solvent extracted high lysine fraction (“SEHLF”). The process of the present invention enables the preparation of SEHLF comprising, on an anhydrous basis, from about 0.6 to about 2.8 wt % lysine. In some embodiments, SEHLF further comprises less than about 1.7 wt % oil, about 0.06 to about 0.22 wt % tryptophan, about 9 to about 25 wt % protein, and about 15 to about 22 wt % neutral detergent fiber. The SEHLF composition has favorable nutritional characteristics as compared to yellow number two corn such as elevated lysine and tryptophan content, a high ratio of oleic to linoleic acid and reduced xanthophyll content.

### Corn

Typical starting material for the extraction process of the present invention is high lysine corn. High lysine corn contains from about 3,000 to about 8,000 ppm total lysine on an anhydrous basis, for example, about 3,000 ppm, about 3,500 ppm, about 4,000 ppm, about 5,000 ppm, about 6,000 ppm, about 7,000 ppm, or even 8,000 ppm total lysine. In some embodiments, the high lysine corn further comprises from about 600 to about 1,000 ppm tryptophan on an anhydrous basis, for example, about 600 ppm, about 650 ppm, about 700 ppm, about 750 ppm, about 800 ppm, about 850 ppm, about 900 ppm, about 950 ppm, or even about 1,000 ppm. In other embodiments, the high lysine corn further comprises from about 3.5 to about 10 percent by weight oil on an anhydrous basis, preferably from about 5 wt % to about 10 wt %, more preferably from about 7 wt % to about 10 wt %. One example of high lysine corn is Mavera™ High Value Corn with Lysine (available from Renessen LLC). As shown in the table 1C, as compared to commodity corn, Mavera™ comprises about 1.6 times the lysine content, about 1.3 times the tryptophan content, about 2 times the oil content and about 1.1 times the protein content.

In other embodiments, corn having a high lysine trait can further comprise one or more additional traits such as high oil, hard endosperm, waxiness, whiteness, nutritional density, high protein or high starch.

### Fractionation

In the fractionation step (also termed degermination), corn is separated into components comprising germ (a high oil and high lysine fraction) and endosperm (a low oil, low lysine and starch rich fraction).

In general, any fractionation process known to those skilled in the art that generates a germ stream having an average particle size range of from about 500 to about 2000 microns, preferably about 1000 microns, is suitable for the practice of the present invention.

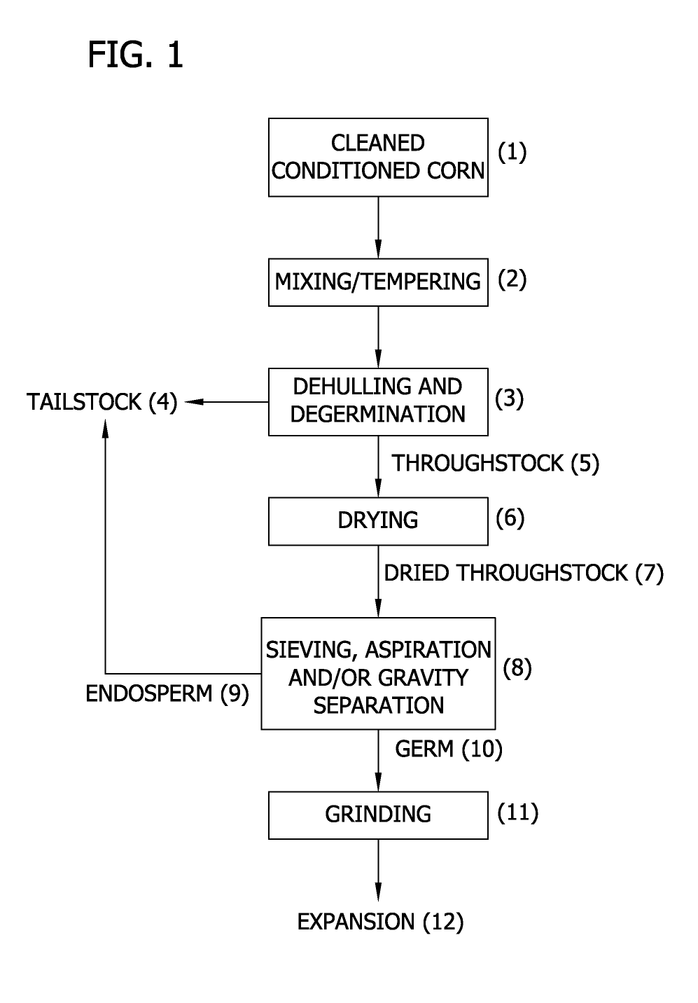

In some fractionation embodiments, corn germ can be produced by a prior art process for the preparation of dry milled corn germ as depicted in FIG. 1. In that process, cleaned and conditioned corn (1) high lysine corn is fed from storage to a mixer for tempering (2). Conditioning and tempering generally (i) favors separation of the bran coat from the endosperm, (ii) facilitates the separation of the germ from the endosperm by making it soft and elastic thereby preventing it from breaking apart during degermination, (iii) reduces the amount of flour produced during degermination, and (iv) results in a high yield of high starch, low oil, low fiber endosperm.

Referring again to FIG. 1, after tempering, the corn kernels are fed into a dehulling and degermination device (3). Examples of such devices include an impact or conical maize degerminator manufactured by Ocrim S.p.A. (Cremona, Italy), a vertical maize degerming machine (VBF) manufactured by Satake Corporation, and a Beall degerminator (Beall Degerminator Company) where impact, abrasion, or shearing action separates the endosperm fraction, termed tailstock (4), from the germ and pericarp fractions, termed throughstock (5).

Recovery of the various fractions is done according to their physical characteristics, for example, particle size and density. Typical separation methods include sieving, aspiration and/or fluidized bed air classification. The coarsest fraction contains large, medium and small particles of endosperm, as measured by their collection on screens ranging in size from 3.5 wire to 14.0 wire. The endosperm (tailstock) is essentially free of germ, and is typically further aspirated to remove bran and dust. The throughstock is smaller in size and lighter in weight than tailstock. It should be noted that the separation and recovery of endosperm from the dehulling and degermination devices is rarely 100 percent, and portions of broken endosperm and endosperm that are loosely attached to the germ (mostly in the form of meal or flour) end up being present in the throughstock.

The throughstock absorbs most of the water during the tempering process. The moisture content of the throughstock is typically lowered by drying (6) from 22 to 25 percent to between 12 and 15 percent to produce dried throughstock (7).

Dried throughstock (7) is subjected to sieving, aspiration and gravity separation (8) to remove additional quantities of endosperm (9) and generate a germ stream (10) that typically further comprises fine particles of residual endosperm and fiber. A fiber stream can be optionally removed from the dried throughstock stream (7) in the sieving, aspiration and gravity separation (8) operation to generate a germ stream (10) that is essentially free of fiber.

The germ or the germ and fiber portion of the throughstock may then be ground (11) to a particle size of from about 500 to about 2000 microns, preferably about 1000 microns. That powder germ may then feed to an expander (12) in an expansion process described below.

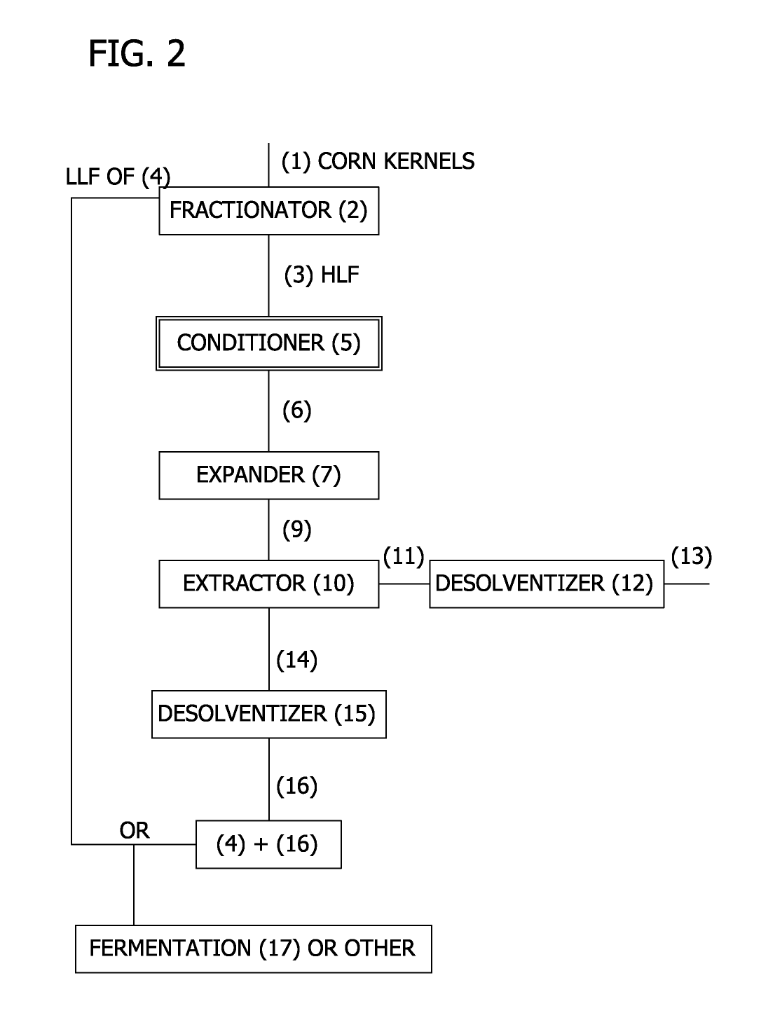

In some preferred embodiments of the present invention, depicted in FIG. 2, the whole high lysine corn kernels (1) are conveyed to a fractionating apparatus (2) such as a Buhler-L apparatus (Buhler GmbH, Germany), a Satake VCW debranning machine (Satake USA, Houston, Tex.), or other equipment wherein the kernels are contacted with an abrasive device to separate a portion of the hull and the germ component from the remainder of the corn material, generally comprising the endosperm. As used herein, the germ component refers to a portion of the corn material containing the corn germ, fractions of corn germ, components of germ, or oil bodies. Where a screen is used as the abrasive device, a portion of the hull and germ component pass through the screen(s) and form the HLF (3). The HLF particle size is generally predominantly less than a size US Number 18 mesh sieve having a 1.00 mm opening, as defined in the American Standards for Testing and Materials 11 (ASTME-11-61) specifications. The material left on the screen(s) comprises the LLF (4) and some germ component. The HLF has a lysine concentration and an oil concentration greater than that of the corn kernels and the LLF has a lysine concentration and an oil concentration less than that of the corn kernels. HLF prepared from high lysine corn generally has an oil concentration of at least about 8% on an anhydrous basis, for example, 8%, 9%, 10% or 15%. HLF prepared from high lysine corn further having high oil content will typically have an oil content of at least about 10.5% by weight on an anhydrous basis, for example, 10.5%, 12%, 15% or 20. LLF generally has an oil concentration of less than about 6% by weight on an anhydrous basis, for example, 5%, 3% or 1%. Fractionation apparatus operating parameters such as, for example, screen size, feed rate, mill speed, air flow through the apparatus, clearance between the screen and the rotating component (e.g., wheel, disc, rotor, roller or contact points such as nips), and combinations thereof, can be varied to affect the extent of corn kernel abrasion and the weight ratio of LLF to HLF. The weight ratio of LLF to HLF is preferably about 50:50, about 55:45, about 60:40, about 65:35, about 70:30, about 75:25, about 80:20, about 85:15 or even about 90:10. The weight ratio range is preferably about 50:50 to about 90:10, about 60:40 to about 85:15, or even about 65:35 to about 80:20.

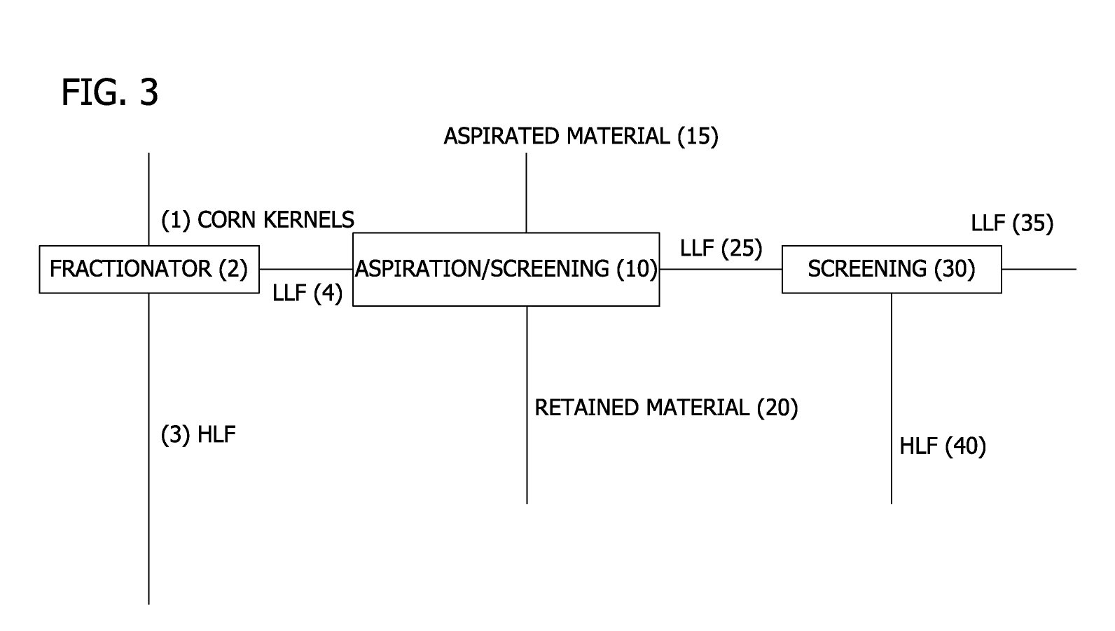

In other preferred fractionation embodiments, LLF is aspirated followed by a second fractionation step comprising one or two screening steps. Referring to FIG. 3, corn kernels (1) are conveyed into a fractionator (2). The resulting LLF (4) is aspirated and then screened (10). Aspiration methods are known in the art. Aspirated material typically comprises about 1 to about 2 percent by weight of the corn kernel (1) weight. Aspirated material (15) generally has a high oil content as compared to HLF and is typically combined with the HLF stream (3). Screening methods are likewise known in the art. The screening step (10) is preferably done using a vibrating screening and shaking device such as that manufactured by Rotex (Rotex, Inc., Cincinnati, Ohio, USA, Model No. 201GP) or Buhler (Buhler GmBH, Germany, MPAD Pansifter). A screen having an opening of from about 4000 micron to about 8000 micron, from about 5000 micron to about 7000 micron, for example about 6000 micron, is preferred. The coarse material retained on top of the screen (20) can be recycled and combined with the fractionator (2) feed. The material passing through the screen is LLF (25) and can be combined with a finished LLF stream or can be processed in a second screening step (30) using a fine screen having an opening of from about 800 to about 1600 micron. The HLF (40) material passing through the screen is typically combined with HLF (3) and the material retained on the screen is LLF (35).

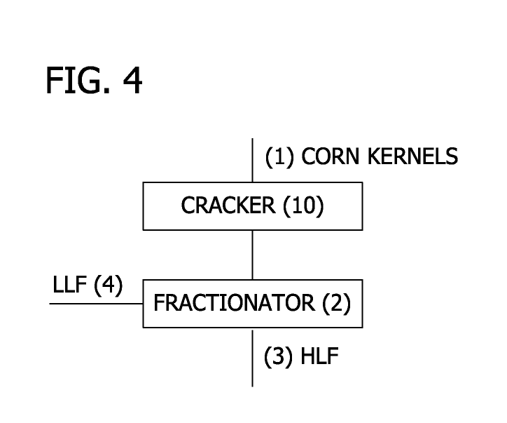

In other fractionation embodiments, as depicted in FIG. 4, high lysine corn kernels (1) are fed to a cracking apparatus (10) prior to entering the fractionating apparatus (2) wherein the LLF (4) and HLF (3) fractions are formed. The kernels can be cracked by methods known to those skilled in the art such as those described, for example, in Watson, S. A. and Ramstad, P. E., Corn: Chemistry and Technology, Chapter 11, American Association of Cereal Chemists, Inc. St. Paul, Minn., USA (1987)

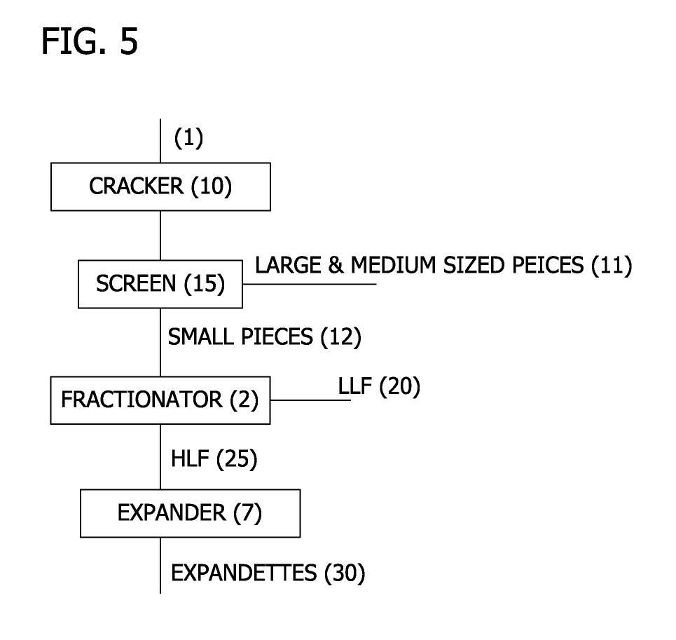

In alternative fractionation embodiments, as depicted in FIG. 5, high lysine corn kernels (1) are fed to a cracking apparatus (10) to produce large and medium sized cracked corn pieces (11) that are separated from small cracked corn pieces (12) by any suitable method, such as screening and/or aspiration (15). In some embodiments, a Rotex screen with a 4 mesh mill grade having 5.46 mm holes (Rotex, Inc., Cincinnati, Ohio, USA, Model No. 201GP) is used.

The large and medium sized cracked corn pieces (11) can be optionally ground in a mill to produce ground cracked corn or flaked in a flaker to produce flaked cracked corn. An example of a suitable mill is a Fitzmill comminuter (Fitzpatrick Company, Elmhurst, Ill., USA) fitted with a 0.6 cm (¼ inch) screen. Useful commercial-scale oilseed flakers can be obtained, for example, from French Oil Mill Machinery Company (Piqua, Ohio, USA), Roskamp Champion (Waterloo, Iowa, USA), Buhler AG (Germany), Bauermeister, Inc. (Memphis, Tenn., USA) and Crown Iron Works (Minneapolis, Minn., USA). After milling or flaking, the material can be optionally added to the HLF stream (25) feeding the expander (7).

The small sized pieces of cracked corn (12) that pass through the screen in the screening process generally have a lysine and oil content greater than the whole corn kernels from which is was produced. It can be optionally aspirated prior to fractionation (2) to remove fines, generally comprising bran.

Stream (12) is fed to the fractionator (2) which generates a LLF stream (20) and a HLF stream (25). The HLF stream is optionally conditioned and is then fed to the expander (7) to produce expandettes (30) suitable for oil extraction.

The LLF, containing the endosperm component, is higher in starch content than HLF. The LLF fraction is suitable for use as starting material for fermentation processes for the preparation of, for example, ethanol or butanol (as depicted in FIG. 2, (17)). LLF can also be used as a feedstock for production of carboxylic acids, amino acids, proteins and plastics, as well as cosmetics and food applications. In some embodiments, prior to fermentation, the LLF is further processed to form a corn protein fraction and a starch fraction. The starch fraction is then used as a feed material in fermentation processes or for the production of food and/or industrial starches. In other embodiments depicted in FIG. 2, the LLF fraction (4) can be used as an animal feed or be combined with SEHLF (16) for use as an animal feed.

In addition to tempering corn before cracking, corn may optionally be tempered prior to abrasive-type fractionation described above. Tempering generally increases the differential hardness between the germ component and the remainder of the corn material and facilitates separation. In tempering, the corn material is heated directly or indirectly and/or water is added. Any tempering method known in the art is acceptable, including, but not limited to, spraying water or sparging steam.

Preferably, water at ambient temperature is sprayed onto the surface of the kernels to adjust the moisture content of the cleaned corn from about 12 to about 20 percent by weight, more preferably about 14 to about 17 percent by weight.

### Conditioning

As described above and depicted in FIG. 2, HLF or germ (collectively termed HLF) can be conditioned (5) with steam prior to expansion.

For HLF having an oil content of less than about 10.5 wt % (anhydrous basis), it is preferred to condition with from about 0.03 to about 0.05, more preferably from about 0.035 to about 0.045 kilograms of steam per kilogram of HLF. Generally, the steam condenses in the HLF resulting in an HLF moisture content increase of from about 3% to about 5% by weight. The steam can be saturated with up to about 10% water. A conditioned HLF temperature of from about 60° C. to about 80° C. is preferred.

In the case of HLF having low moisture, the expander feed moisture content can be adjusted to greater than about 12% by weight prior to expander treatment. In some embodiments, that moisture content can be achieved by heating the HLF with steam to a temperature of 80° C., 75° C., 70° C., 65° C. or even 60° C. During heating, steam condenses in the HLF thereby increasing the water content from about 3% to about 5% by weight. A water content of greater than about 12% by weight is preferred, with a range of from about 12% to about 16% preferred. An example of a suitable conditioner is a Buhler Model DPSD homogenizer (Buhler GmBH, Germany).

In some alternative embodiments, the HLF conditioner is integral with the expander barrel (described below) thereby forming an extended barrel comprising a first stage HLF conditioning zone and a second stage expansion zone. For example an expander having an extended barrel and extended internal screw can be utilized. The expander barrel section where the HLF is fed forms the first zone where conditioning steam is added to achieve the desired temperature range of from about 60° C. to about 80° C. and/or the desired moisture content of greater than about 12 wt %. The conditioned HLF then passes into the second stage expansion zone where sufficient steam is added to increase the temperature to the preferred range of from about 140° C. to about 165° C. as described more fully below.

### Expansion

As depicted in FIG. 2, HLF feed (6) is treated in an expander (7) under high shear, temperature and pressure conditions to generate expandettes (9) that enable the preparation of SEHLF (16) having an oil content of less than about 1.7 wt % on an anhydrous basis.

Expansion generally involves four stages. In the first stage, a conveyor, such as a screw conveyor, transfers HLF feed material (6) into the expander (7) at a predetermined rate selected to provide the desired residence time in an extruder treatment zone. In the second stage, the adjusted HLF material enters a treatment zone where it is heated with steam under high pressure, temperature and shear conditions. In the third stage, the hot, pressurized, HLF material is extruded out of the treatment zone through die head slots and into an expansion zone characterized by reduced (e.g., ambient) temperature and pressure conditions. In the expansion zone, the pressure of the extruded HLF drops. The pressure release causes the volume of the treated HLF to expand resulting in rapid evaporation, or flashing, of a portion of the contained water with concomitant temperature decrease. In a fourth stage, the expandettes are cut to length by a rotating knife assembly thereby fixing the expandette size. A representative sample of expandettes typically includes expandettes having dimensions ranging from about 0.5 cm×0.5 cm to 0.5 cm to about 8 cm×4 cm×2 cm, but breakage results in a small percentage of fine material. An example of a suitable expander is the Buhler Condex DFEA Expander Model 220 (Buhler GmBH, Germany).

In general, any positive displacement method of feeding the HLF to the expander is suitable, with screw feeders generally preferred. The feed rate is generally selected and controlled in order to achieve the desired residence time in the expander, with the absolute rate in kilograms per hour primarily being a function of expander barrel volume and feed rate. An expander barrel residence time of less than about 10 seconds, 5 seconds or even less than about 0.5 second is preferred. In general, lower residence times at expander temperature conditions are preferred to minimize lysine decomposition or complexation.

Expander temperature and pressure are typically selected to provide an expandette having desired characteristics of density, porosity and durability that enable efficient oil extraction under commercial conditions.

An expander pressure of from about 20 bars to about 40 bars is generally preferred. The pressure typically ranges from about 25 bar to 35 bar, from about 27 bar to about 34 bar, from about 28 bar to about 33 bar, from about 28 bar to about 32 bar, or even from about 29 bar to about 31 bar.

An expander temperature range of from 140° C. to about 165° C., from about 140° C. to about 160° C., 140° C. to about 155° C. or from about 140° C. to about 150° C. is typically preferred. In some embodiments, where the HLF has an oil content of less than about 9% by weight (10.5% dry basis), a temperature range of from about 140° C. to about 150° C. is preferred. In other embodiments, where the HLF has an oil content of greater than about 10.5% (anhydrous basis) by weight, a temperature range of from, from about 150° C. to about 165° C. is preferred, more preferably from about 155° C. to about 165° C.

The expander temperature is typically achieved with a total steam input to the conditioner and the expander of from about 0.04 to about 0.075, from about 0.04 to about 0.07, from about 0.042 to about 0.075, from about 0.042 to about 0.07, from about 0.042 to about 0.065, or even from about 0.042 to about 0.062 kg of steam per kg of HLF. The steam can be saturated up to about 10% water.

For HLF that has been conditioned with steam, a steam feed rate to the expander of from about 0 to about 0.03 kg of steam per kg of HLF is preferred. For HLF having an oil content of greater than about 9% by weight (10.5% dry basis), and that has not been conditioned with steam, a steam rate to the expander barrel of from about 0.040 to about 0.075 kg of steam per kg of HLF is preferred, more preferably from about 0.042 to about 0.062 kg of steam per kg of HLF. In some embodiments, high oil content HLF can be optionally conditioned with about 0.001 to about 0.02 kg of steam per kg of HLF and the remainder of the steam is added to the expander barrel providing a total steam addition of from about 0.042 to about 0.062 kg of steam per kg of HLF.

In some embodiments, HLF prepared from high lysine, high oil corn is expanded at a steam feed rate to the expander barrel of from about 0.042 to about 0.06 kg of steam per kg of HLF, the expander die pressure is regulated from about 27 bar to about 33 bar, and the expander barrel temperature is regulated from about 155° C. to about 165° C. In alternative embodiments, the HLF is conditioned with steam prior to expansion.

In another embodiments, HLF prepared from high lysine corn not having high oil is conditioned with from about 0.03 to about 0.05 kg steam per kg HLF and is expanded at a steam feed rate to the expander barrel calculated to provide a total steam input to the conditioner and expander of from about 0.042 to about 0.06 kg of steam per kg of HLF, the expander die pressure is regulated from about 27 bar to about 33 bar, and the expander barrel temperature is regulated from about 140° C. to about 150° C.

In some alternative embodiments, HLF conditioning is done in the expander using an extended expander barrel as described above. The conditioner is integral with the expander barrel thereby forming an extended barrel comprising a first stage feed conditioning zone, a second stage expander treatment zone (i.e., expansion), a third stage extrusion zone and a fourth stage expandette cutting zone. In the conditioning zone, HLF can be adjusted to a preferred moisture content of from about 12% to about 16% at a preferred temperature of from about 60° C. to about 80° C. using a preferred steam feed rate of from about 0.03 to about 0.05 kg of steam per kg of HLF as described above.

In some embodiments, the expandettes are dried to a moisture content of less than about 10% by weight prior to solvent extraction and desolventization in order to prevent expandette agglomerization in the desolventization operation. In general, drying is done by passing gas such as air or nitrogen at a temperature of between about 50° C. and about 95° C. through an expandette bed. In other embodiments, air having a temperature of about 75° C. is passed through an expandette bed until the relative humidity of the outlet air is less than about 80%.

### Extraction

As described in more detail in WO 05/108533, and as depicted in FIG. 2, expanded fractionated HLF (9) can be extracted with a solvent to generate an extracted corn meal. In some embodiments, expanded HLF is subjected to a solvent extraction step (10) to yield wet solvent extracted HLF (14) (“crude SEHLF”) and miscella (11). Solvent extraction of oil seeds is well known in the art. The extraction step can be accomplished by using any of a variety of immersion type or percolation type extractors. Generally, any device can be used that will contact the solvent with the oil bearing expandettes and allow for sufficient separation of the oil from the HLF, followed by sufficient separation of the miscella from the HLF is suitable for the practice of the present invention.

In one process option, in an optional extraction method, supercritical carbon dioxide extraction can be used instead of organic solvent extraction. In this method, liquefied carbon dioxide is the solvent that is used to extract oil from a bed of HLF expandettes. After extraction, the liquid carbon dioxide and oil mixture is collected and depressurized. Upon depressurization, the carbon dioxide evaporates leaving the oil.

### Solvent Reclamation

As described in more detail in WO 05/108533, as depicted in FIG. 2, crude SEHLF (14) (i.e., SEHLF comprising a wetting quantity of solvent) is processed in desolventization operation (15) to yield SEHLF (16) and reclaimed solvent; and miscella (11) is processed in desolventization operation (12) to yield corn oil (13) and reclaimed solvent. Solvent is reclaimed from the crude SEHLF and miscella using any typical method such as rising film evaporation, drying, flashing, or any combination thereof.

Desolventized miscella (13) (termed crude corn oil) can be stored and/or undergo further processing. Crude corn oil can be refined to produce a final corn oil product. Methods for refining crude corn oil to obtain final corn oil are known to those skilled in the art. For example, Hui, Bailey's Industrial Oil and Fat Products, 5th Ed., Vol. 2, Wiley and Sons, Inc., pages 125-158 (1996), the disclosure of which is incorporated by reference, describes corn oil composition and processing methods. Crude oil isolated using the methods described herein is of high quality and can be further refined using conventional oil refining methods. The refining may include bleaching and/or deodorizing the oil or mixing the oil with a caustic solution for a sufficient period of time to form a mixture that is thereafter centrifuged to separate the oil.

### SEHLF Characterisitics

The SEHLF of the present invention comprises lysine, tryptophan and other amino acids, oil, protein, starch, and neutral detergent fiber (“NDF”), with concentrations of those components reported on an anhydrous wt % basis. A total lysine content of from about 0.6 wt % to about 2.8 wt %, for example, about 0.6 wt %, 0.7 wt %, 0.8 wt %, 0.9 wt %, 1.0 wt %, 1.1 wt %, 1.2 wt %, 1.3 wt %, 1.4 wt %, 1.5 wt %, 1.6 wt %, 1.7 wt %, 1.8 wt %, 1.9 wt %, 2.0 wt %, 2.1 wt %, 2.2 wt %, 2.3 wt %, 2.4 wt %, 2.5 wt %, 2.6 wt %, 2.7 wt % or even about 2.8 wt %, and ranges thereof, is preferred. A free lysine content of from about 0.3 wt % to about 0.5 wt % is preferred. The process of the present invention provides a total lysine recovery (yield), based on the lysine content of the high lysine corn kernels, of at least 80%, 85%, 90%, 91%, 92%, 93%, 94% or even 95%. A total tryptophan content of from about 0.06 wt % to about 0.22 wt %, for example about 0.06 wt %, 0.07 wt %, 0.08 wt %, 0.09 wt %, 0.10 wt %, 0.11 wt %, 0.12 wt %, 0.13 wt %, 0.14 wt %, 0.15 wt %, 0.16 wt %, 0.17 wt %, 0.18 wt %, 0.19 wt %, 0.20 wt %, 0.21 wt % or even about 0.22 wt %, and ranges thereof, is preferred. The preferred content of other amino acids (on an anhydrous basis) is listed in the table below.

| Amino Acid | wt % amino acid |
|---|---|
| Total alanine | 0.7 to 1.3 |
| Total arginine | 0.7 to 1.6 |
| Total aparagine + asparatate | 0.8 to 1.6 |
| Total cysteine | 0.2 to 0.4 |
| Total glutamine + glutamate | 1.6 to 3.3 |
| Total glycine | 0.5 to 1.1 |
| Total histidine | 0.3 to 0.6 |
| Total hydroxylysine | 0.03 to 0.05 |
| Total hydroxyproline | 0.04 to 0.06 |
| Total isoleucine | 0.4 to 0.7 |
| Total leucine | 1 to 1.7 |
| Total lanthionine | 0.03 to 0.05 |
| Total methionine | 0.2 to 0.4 |
| Total ornithine | 0.01 to 0.02 |
| Total phenylalanine | 0.4 to 0.8 |
| Total proline | 0.8 to 1.4 |
| Total serine | 0.4 to 0.9 |
| Total taurine | 0.06 to 0.09 |
| Total threonine | 0.4 to 0.8 |
| Total tyrosine | 0.3 to 0.7 |
| Total valine | 0.5 to 1.1 |

A SEHLF protein content of from about 9 wt % to about 25 wt %, for example about 9 wt %, 10 wt %, 11 wt %, 12 wt %, 13 wt %, 14 wt %, 15 wt %, 16 wt %, 17 wt %, 18 wt %, 19 wt %, 20 wt %, 21 wt %, 22 wt %, 23 wt %, 24 wt % or even about 25 wt %, and ranges thereof, is preferred. In some embodiments, a ratio of SEHLF total lysine to total SEHLF protein of from about 0.06 to about 0.3, for example about 0.08, 0.1, 0.15, 0.2, 0.25, or even about 0.3 or more, and ranges thereof, is preferred. In other embodiments, a ratio of SEHLF tryptophan to total SEHLF protein of about 0.005, 0.006, 0.007, 0.008, 0.009, 0.01, 0.011, 0.012, 0.013, 0.014 or even about 0.015 or more, and ranges thereof, is preferred. In other embodiments, an oil content of less than about 1.7%, for example, 1.6 wt %, 1.5 wt %, 1.4 wt %, 1.3 wt %, 1.2 wt %, 1.1 wt %, 1 wt %, 0.9 wt %, 0.8 wt %, 0.7 wt %, 0.6 wt %, 0.5 wt %, 0.4 wt %, or even about 0.3 wt %, and ranges thereof, is preferred. A starch content of from about 30 wt % to about 70 wt %, from about 35 wt % to about 70 wt %, or even from about 40 wt % to about 70 wt % is preferred. A NDF content of from about 12 wt % to about 24 wt %, from about 13 wt % to about 24 wt %, from about 14 wt % to about 24 wt %, from about 15 wt % to about 24 wt %, from about 16 wt % to about 24 wt %, from about 17 wt % to about 24 wt %, or even from about 18 wt % to about 24 wt % is preferred. A weight ratio of protein to starch of from about 0.15 to about 0.8, from about 0.15 to about 0.7, from about 0.15 to about 0.6, from about 0.15 to about 0.55, from about 0.15 to about 0.5, from about 0.15 to about 0.45, from about 0.15 to about 0.4, or even from about 0.15 to about 0.35 is preferred. SEHLF of the present invention also comprises acid detergent fiber (“ADF”) with concentrations of less than about 5 wt %, for example, 4.5 wt %, 4 wt %, 3.5 wt %, 3 wt %, 2.5 wt % or even about 2 wt % or less, and ranges thereof, preferred. A ratio of oleic acid to linoleic acid of about 0.4, 0.45, 0.5, 0.55, 0.6, 0.65, 0.7, 0.75, 0.8, 0.85, 0.9, 0.95 or about 1, or ranges thereof, is preferred. A xanthophyll concentration, on an anhydrous basis, of about 15 mg/kg, 14 mg/kg, 13 mg/kg, 12 mg/kg, 11 mg/kg, 10 mg/kg, 9 mg/kg, 8 mg/kg, 7 mg/kg, 6 mg/kg or about 5 mg/kg, or ranges thereof, is preferred.

### Feed Rations

Animal feed rations having unique nutritional properties can be prepared from the SEHLF of the present invention yielding feed rations requiring reduced amounts of supplemental lysine and tryptophan, other amino acids, proteins and/or nutritional components to meet animal nutrition requirements.

Some animal diets comprise number two yellow corn as the main cereal source. In the case of swine dietary requirements, yellow number 2 may not provide sufficient dietary requirement amounts of lysine and tryptophan. Lysine and tryptophan supplements are typically added to yellow number 2 in the form of soybean meal, meat and bone meal, canola meal, wheat middlings, etc. and/or synthetic versions in order to meet the animal's essential amino acid requirements. The high lysine SEHLF of the present invention can be combined with other ingredients to produce animal feeds. Ingredients include, for example, vitamins, minerals, high oil seed-derived meal, meat and bone meal, salt, amino acids, feather meal, fat, oil-seed meal, corn, sorghum, wheat by-product, wheat-milled by-product, barley, tapioca, corn gluten meal, corn gluten feed, bakery by-products, full fat rice bran, rice hulls. The animal feed may be tailored for particular uses such as feed for poultry, swine, cattle, equine, aquaculture and pets, and can be tailored to animal growth phases.

The table below shows a comparison of lysine and tryptophan concentrations in swine feed rations made using yellow number two corn and SEHLF prepared from Mavera™ High Lysine Corn.

| | Y#2 Corn (%) | SEHLF |
|---|---|---|
| Feed Ration Ingredient | | |
| Corn % | 80 | — |
| SEHLF % | — | 97.5 |
| Soybean Meal % | 12.5 | — |
| Meat & Bone Meal % | 6.6 | — |
| Salt % | 0.4 | 0.4 |
| Premix % | 0.15 | 0.15 |
| Fat % | 0.1 | 2 |
| Lysine Supplement | 0.08 | — |
| Feed Ration Concentration | | |
| Lysine % | 0.81 | 0.81 |
| Tryptophan % | 0.14 | 0.13 |

As can be seen from the table, SEHLF prepared from Mavera™ High Lysine Corn does not require lysine and tryptophan supplementation.

### DEFINITIONS

As used herein, the term “whole corn” refers to a kernel that has not been separated into its constituent components, e.g., the hull, endosperm, tip cap, pericarp, and germ have not been purposely separated.

“Fines” refers to particles that pass through a U.S. No. 18 sieve having a 1 mm opening (as defined in ASTME-11-61 specifications).

“Predominant” or “predominantly” means at least about 50%, preferably at least about 75% and more preferably at least about 90% by weight.

“Total” in reference to an amino acid refers to the sum of amino acid contained in proteins and in free form.

Having described the invention in detail, it will be apparent that modifications and variations are possible without departing from the scope of the invention defined in the appended claims.

### EXAMPLES

The following non-limiting examples are provided to further illustrate the present invention.

### Example 1

High oil corn was processed according to the process of the present invention wherein the corn was fractionated into LLF and HLF fractions in a weight ratio of LLF to HLF of about 64 to 36. The HLF fraction was conditioned to 14% moisture at 27° C. The conditioned HLF fraction was expanded at 30 bar and 150° C. to generate HLF expandettes. SEHLF was prepared from the HLF expandettes by extracting with hexane and desolventizing in a desolventizer/toaster (“DT”) apparatus at a first stage heating final temperature of 65° C. and a second stage steam stripping final temperature of 105° C. and a second stage residence time of about one hour. The SEHLF composition was analyzed with the results reported in Table 1A on an anhydrous basis. Also included in Table 1A is a typical composition of yellow #2 corn with concentrations reported on an anhydrous basis.

TABLE 1A

| Component¹ | Yellow number 2 Corn | SEHLF |
|---|---|---|
| Protein % | 8.3 | 12.46 |
| Fat % | 3.9 | 1.14 |
| Ash % | 1.2 | 2.90 |
| NDF % | 7.8 | 13.28 |
| ADF % | 2.0 | 2.56 |
| Starch % | 73.0 | 61.05 |
| Calcium % | 0.03 | 0.03 |
| Phosphorus % | 0.28 | 0.64 |
| Total Lysine % | 0.27 | 0.56 |
| Cysteine % | 0.21 | 0.28 |
| Isoleucine % | 0.29 | 0.40 |
| Methionine % | 0.19 | 0.25 |
| Threonine % | 0.29 | 0.45 |
| Tryptophan % | 0.06 | 0.11 |
| Valine % | 0.40 | 0.60 |
| Arginine % | 0.40 | 0.78 |
| Histidine % | 0.25 | 0.36 |
| Leucine % | 0.99 | 1.12 |
| Phenylalanine % | 0.41 | 0.52 |

¹SEHLF had moisture concentrations of 10.04%.

Material balance calculations based on fractionation of yellow number 2 corn to yield SEHLF and LLF compositions results in the data reported in Table 1B on a basis of 1 kilogram of starting corn.

TABLE 1B

| Component | SEHLF | LLF |
|---|---|---|
| Protein (wt %) | 12.46 | 6 |
| Lysine (wt %) | 0.56 | 0.11 |
| Tryptophan (wt %) | 0.11 | 0.032 |

Mavera™ high lysine corn was analyzed and compared to yellow number 2 corn with the results reported in Table 1C on a wet basis.

TABLE 1C

| Component | Yellow #2 Corn | Mavera ™ |
|---|---|---|
| Oil (wt %) | 3.5 | 6.5 |
| Protein (wt %) | 8.0 | 8.5 |
| Lysine (wt %) | 0.25 | 0.4 |
| Tryptophan (wt %) | 0.056 | 0.07 |

The expected composition of SEHLF prepared from Mavera™ high lysine corn (“SEHLF 1”) was calculated from the component distribution of Table 1B, assuming a LLF to HLF split of 64 to 36. The calculations are reported in Table 1D with “SEHLF 2” representing SEHLF prepared from commodity corn as reported in Table 1B.

TABLE 1D

| Component | SEHLF 1 | SEHLF 2 |
|---|---|---|
| Protein (wt %) | 12.8 | 12.5 |
| Lysine (wt %) | 0.82 | 0.56 |
| Tryptophan (wt %) | 0.13 | 0.11 |

### Example 2

About 120,000 bushels of a corn variety having high oil and high lysine traits was processed according to the process of the present invention wherein the corn was fractionated into LLF and HLF fractions in a ratio of LLF to HLF of about 63 to 37. The HLF fraction was conditioned to 14% moisture at 27° C. The conditioned HLF fraction was expanded at 25 bar and 150° C. to generate HLF expandettes. SEHLF was prepared from the HLF expandettes by extracting with hexane and desolventizing in a desolventizer/toaster apparatus at a first stage heating final temperature of 65° C. and a second stage steam stripping final temperature of 105° C. and a second stage residence time of about 40 minutes.

The high lysine/high oil corn was grown on three farms in Iowa, USA. The corn was analyzed for free lysine and total lysine content. Table 2A summarizes the results from the farm samples.

TABLE 2A

| | |
|---|---|
| Free Lysine | Total Lysine |

| Farm | | ppm | ppm db | ppm | ppm db |
|---|---|---|---|---|---|
| 1 | Average | 839 | 1,005 | 3,128 | 3,747 |
| | Std. Dev. | 100 | 118 | 233 | 271 |
| 2 | Average | 1,078 | 1,293 | 3,348 | 4,016 |
| | Std. Dev. | 151 | 180 | 260 | 318 |
| 3 | Average | 1,258 | 1,470 | 3,589 | 4,196 |
| | Std. Dev. | 171 | 198 | 177 | 208 |

The lysine content shows a difference between the farms. It is believed that growing conditions are likely reasons for the difference.

SEHLF samples were collected and tested for free and total lysine by HPLC. Table 2B summarizes the results of the SEHLF testing along with results on total lysine from SEHLF samples produced while running yellow, #2 grade corn (designated as “corn” in Table 2B). The corn was collected before the corn heater. The low lysine fraction (LLF) repeat samples LLF1 and LLF2 were in-process samples. These two streams were combined to make the final LLF product. The high lysine fraction (HLF) sample was collected before feeding the expander system. The white flake sample is a sample of the meal coming out of the extractor before feeding the desolventizer/toaster (DT). The SEHLF1 and SEHLF2 repeat samples were collected after the meal cooler before being transferred to storage. The SEHLF3 sample was a comparative sample prepared from yellow number 2 corn and collected after the meal cooler before being transferred to storage.

TABLE 2B

| | | Free Lysine | | Total Lysine | | |
|---|---|---|---|---|---|---|
| | | ppm | ppm db | ppm | wt % db | ppm db |
| Corn | Average | 970 | 1,145 | 3,518 | 0.41 | 4,152 |
| | Std. Dev. | 241 | 288 | 265 | — | 318 |
| LLF1 | Average | 140 | 165 | 1,434 | 0.17 | 1,692 |
| | Std. Dev. | 50 | 58 | 148 | — | 174 |
| LLF2 | Average | 100 | 120 | 1,307 | 0.16 | 1,561 |
| | Std. Dev. | 49 | 58 | 92 | — | 104 |
| HLF | Average | 2,600 | 2,971 | 7,526 | 0.86 | 8,602 |
| | Std. Dev. | 345 | 388 | 677 | — | 772 |
| White Flake | Average | 3,278 | 3,619 | 9,065 | 1.0 | 10,036 |
| | Std. Dev. | 221 | 255 | 2,073 | — | 2,272 |
| SEHLF1 | Average | 2,968 | 3,346 | 8,007 | 0.91 | 9,139 |
| | Std. Dev. | 164 | 192 | 271 | — | 328 |
| SEHLF2 | Average | 2,991 | 3,490 | 8,687 | 1.01 | 10,139 |
| | Std. Dev. | 163 | 186 | 450 | — | 553 |
| SEHLF3 | Average | — | — | — | 0.46 | 4593 |
| | Std. Dev. | — | — | — | — | 367 |

The analysis for total lysine was repeated and the results are reported in Table 2C below.

TABLE 2C

| | | Total Lysine | | |
|---|---|---|---|---|
| | | ppm | ppm db | wt % db |
| Corn | 1 sample | 3900 | 4668 | 0.47 |
| LLF1 | 1 sample | 1900 | 2284 | 0.23 |
| LLF2 | 1 sample | 1600 | 1937 | 0.19 |
| HLF | 1 sample | 9000 | 10513 | 1.05 |
| SEHLF | Average | 9009 | 10569 | 1.06 |
| | Std. Dev. | 266 | 392 | — |

The LLF samples show lysine concentrations lower than the corn while HLF and meal samples show concentrations higher than the corn, which was expected. There was no drop in the lysine content from the white flake sample to the SEHLF sample. This indicates that the DT does not appreciably destroy or degrade the lysine.

The volumes of corn processed and the volume of LLF and SEHLF produced were monitored during this run so total lysine recoveries could be calculated. Table 2D shows the results for free lysine and Table 2E shows the results for total lysine.

TABLE 2D

| | Metric tons | Free lysine | | |
|---|---|---|---|---|
| | processed | (ppm) | lysine (kg) | % of feed |
| Corn | 506 | 970 | 491.2 | |
| LLF | 320.1 | 140 | 44.9 | 9.1 |
| SEHLF | 131.5 | 2991 | 393.2 | 80.1 |
| Corn oil | 23.4 | 0 | 0 | 0 |

| | |
|---|---|
| Total Lysine Recovery | 89.2 |

TABLE 2E

| | Metric tons | Total lysine | | |
|---|---|---|---|---|
| | processed | (ppm) | lysine (kg) | % of feed |
| Corn | 506 | 3518 | 1780 | |
| LLF | 320.1 | 1434 | 459 | 25.8 |
| SEHLF | 131.5 | 8687 | 1142 | 64.2 |
| Corn oil | 23.4 | 0 | 0 | 90 |

Total Lysine Recovery

Approximately 80% of the free lysine and 65% of the total lysine was recovered in the SEHLF meal. The LLF fraction contained 9% of the free lysine and 26% of the total lysine. About 10% of the mass of both free lysine and total lysine was not accounted for. The actual production split for this run was 63% LLF and 26% SEHLF, so the lysine appeared to be preferentially separating into the SEHLF fraction.

The process of the present invention concentrated lysine into the SEHLF fraction. The SEHLF contained approximately 2.4 times the content of lysine than the corn feed to the process. The lysine content in the SEHLF made from the high oil and high lysine variety was approximately 2.2 times higher than lysine content made from yellow, #2 grade corn. It appears that the extraction process, in particular the DT, does not degrade the higher lysine content. It is not clear if the process can recover the entire amount of lysine since this analysis included a missing amount of lysine of 10 percent of the feed. More analysis would be required to determine if it is an actual loss in the process or can be accounted for by analytical variability. Under one theory, and without being bound to any particular theory, the process loss could come from the production of expandettes wherein the heat and moisture can cause the lysine to from complexes that cannot be detected by standard lysine analytical methods.

The SEHLF and LLF were further analyzed by near infrared adsorption spectroscopy (“NIR”) and wet chemistry methods for content of moisture, oil, protein, starch, NDF, ADF and ash. The results are reported in Table 2F below.

TABLE 2F

| | SEHLF | LLF |
|---|---|---|
| Moisture (NIR) | | |
| Average | 12.13 | 15.33 |
| Standard Deviation | 0.87 | 0.8 |
| High | 13.45 | 16.91 |
| Low | 10.16 | 13.15 |
| Moisture (wet chemistry) | | |
| Average | 11.79 | 12.04 |
| Standard Deviation | 0.82 | 1.22 |
| High | 13.43 | 14.97 |
| Low | 9.77 | 10.35 |
| Oil (wet basis - NIR) | | |
| Average | 1.5 | 1.33 |
| Standard Deviation | 0.55 | 0.3 |
| High | 3.64 | 1.9 |
| Low | 0.66 | 0.5 |
| Oil (wet basis - wet chemistry) | | |
| Average | 1.31 | 1.09 |
| Standard Deviation | 0.58 | 0.2 |
| High | 3.28 | 1.68 |
| Low | 0.74 | 0.68 |
| Oil (dry basis - NIR) | | |
| Average | 1.7 | 1.57 |
| Standard Deviation | 0.6 | 0.35 |
| High | 4.05 | 2.22 |
| Low | 0.76 | 0.58 |
| Oil (dry basis - wet chemistry) | | |
| Average | 1.46 | 1.24 |
| Standard Deviation | 0.66 | 0.22 |
| High | 3.66 | 1.93 |
| Low | 0.85 | 0.78 |
| Protein (wet basis) | | |
| Average | 11.98 | — |
| Standard Deviation | 0.42 | — |
| High | 12.75 | — |
| Low | 10.96 | — |
| Protein (dry basis) | | |
| Average | 13.47 | — |
| Standard Deviation | 1.63 | — |
| High | 14.59 | — |
| Low | 12.47 | — |
| Starch (wet basis - NIR) | | |
| Average | 40.29 | — |
| Standard Deviation | 6.42 | — |
| High | 57.58 | — |
| Low | 26.07 | — |
| NDF (wet basis) | | |
| Average | 17.08 | — |
| Standard Deviation | 2.44 | — |
| High | 25.27 | — |
| Low | 13.5 | — |
| ADF (wet basis) | | |
| Average | 3.77 | — |
| Standard Deviation | 0.51 | — |
| High | 5.07 | — |
| Low | 2.84 | — |
| Ash (wet basis) | | |
| Average | 4.35 | — |
| Standard Deviation | 3.56 | — |
| High | 26.07 | — |
| Low | 3.06 | — |
| Gel Starch (wet basis) | | |
| Average | 76.81 | — |
| Standard Deviation | 8.17 | — |
| High | 96.77 | — |
| Low | 57.73 | — |
| Gel Starch Coefficient (wet basis) | | |
| Average | 0.29 | — |
| Standard Deviation | 0.04 | — |
| High | 0.37 | — |
| Low | 0.2 | — |

### Example 3

The corn and corn fractions from Example 2 were analyzed for alanine, arginine, asparagine, cysteine, glutamate, glutamine, glycine, histidine, hydroxylysine, hydroxyproline, isoleucine, lanthionine, leucine, methionine, ornithine, phenylalanine, proline, serine, taurine, threonine, tryptophan, tyrosine and valine. The results are reported in Tables 3A(1) to 3V(3) below.

The analysis for alanine is reported in Table 3A(1) below.

TABLE 3A(1)
Alanine

| | | Free Alanine | | Total Alanine | |
|---|---|---|---|---|---|
| | | ppm | ppm db | ppm | ppm db |
| Farm1 | Average | 96 | 115 | 5,311 | 6,361 |
| | Std. Dev. | 22 | 27 | 350 | 387 |
| Farm2 | Average | 108 | 129 | 5,670 | 6,801 |
| | Std. Dev. | 15 | 18 | 126 | 166 |
| Farm3 | Average | 80 | 93 | 5,216 | 6,099 |
| | Std. Dev. | 9 | 10 | 128 | 156 |
| Corn | Average | 81 | 95 | 5,530 | 6,525 |
| | Std. Dev. | 7 | 9 | 234 | 295 |
| LLF1 | Average | 23 | 28 | 4,940 | 5,829 |
| | Std. Dev. | 4 | 4 | 235 | 293 |
| LLF2 | Average | 18 | 22 | 4,879 | 5,828 |
| | Std. Dev. | 2 | 3 | 143 | 192 |
| HLF | Average | 168 | 191 | 6,448 | 7,370 |
| | Std. Dev. | 20 | 22 | 428 | 499 |
| White | Average | 208 | 230 | 7,454 | 8,253 |
| Flake | Std. Dev. | 7 | 8 | 1,682 | 1,842 |
| SEHLF1 | Average | 220 | 248 | 7,025 | 7,919 |
| | Std. Dev. | 11 | 12 | 194 | 216 |
| SEHLF2 | Average | 197 | 230 | 7,709 | 8,996 |
| | Std. Dev. | 14 | 16 | 334 | 377 |
| SEHLF3 | Average | — | — | — | 7,093 |
| | Std. Dev. | — | — | — | 526 |

The analysis for total alanine was repeated and the results are reported in Table 3A(2) below.

TABLE 3A(2)

Total Alanine

| | | ppm | ppm db |
|---|---|---|---|
| Corn | 1 sample | 5,600 | 6,703 |
| LLF1 | 1 sample | 5,200 | 6,250 |
| LLF2 | 1 sample | 5,400 | 6,536 |
| HLF | 1 sample | 7,000 | 8,177 |
| SEHLF2 | Average | 7,591 | 8,904 |
| | Std. Dev. | 145 | 526 |

Total alanine recovery is shown in Table 3A(3).

TABLE 3A(3)

| | | | | Total |
|---|---|---|---|---|
| | Corn | LLF2 | SEHLF2 | Recovered |
| Metric Tons Processed | 506 | 320.1 | 131.5 | — |
| Free Alanine Produced kg) | 40.8 | 7.3 | 25.9 | — |
| Free Alanine Recovered | — | 18 | 64 | 82 |
| (% of feed) | | | | |
| Total Alanine Produced | 2,799 | 1,582 | 1,014 | — |
| (kg) | | | | |
| Total Alanine Recovered | — | 57 | 36 | 93 |
| (% of feed) | | | | |

The analysis for arginine is reported in Table 3B(1) below.

TABLE 3B(1)
Arginine

| | | Free Arginine | | Total Arginine | |
|---|---|---|---|---|---|
| | | ppm | ppm db | ppm | ppm db |
| Farm1 | Average | 103 | 124 | 4,142 | 4,962 |
| | Std. Dev. | 8 | 10 | 175 | 186 |
| Farm2 | Average | 102 | 123 | 4,304 | 5,162 |
| | Std. Dev. | 5 | 6 | 38 | 43 |
| Farm3 | Average | 107 | 125 | 4,102 | 4,797 |
| | Std. Dev. | 12 | 14 | 149 | 178 |
| Corn | Average | 106 | 125 | 4,320 | 5,097 |
| | Std. Dev. | 10 | 12 | 102 | 134 |
| LLF1 | Average | 26 | 31 | 2,664 | 3,144 |
| | Std. Dev. | 4 | 5 | 183 | 215 |
| LLF2 | Average | 21 | 25 | 2,529 | 3,020 |
| | Std. Dev. | 3 | 4 | 106 | 117 |
| HLF | Average | 233 | 266 | 7,532 | 8,610 |
| | Std. Dev. | 28 | 32 | 570 | 662 |
| White | Average | 307 | 338 | 8,536 | 9,452 |
| Flake | Std. Dev. | 22 | 24 | 1,903 | 2,086 |
| SEHLF1 | Average | 282 | 318 | 8,088 | 9,117 |
| | Std. Dev. | 11 | 12 | 286 | 319 |
| SEHLF2 | Average | 298 | 348 | 8,913 | 10,401 |
| | Std. Dev. | 40 | 47 | 488 | 574 |
| SEHLF3 | Average | — | — | — | 6,657 |
| | Std. Dev. | — | — | — | 533 |

The analysis for total arginine was repeated and the results are reported in Table 3B(2) below.

TABLE 3B(2)

Total Arginine

| | | ppm | ppm db |
|---|---|---|---|
| Corn | 1 sample | 4,000 | 4,788 |
| LLF1 | 1 sample | 2,600 | 3,125 |
| LLF2 | 1 sample | 2,500 | 3,026 |
| HLF | 1 sample | 7,700 | 8,994 |
| SEHLF2 | Average | 8,045 | 9,438 |
| | Std. Dev. | 242 | 340 |

Total arginine recovery is shown in Table 3B(3).

TABLE 3B(3)

| | | | | Total |
|---|---|---|---|---|
| | Corn | LLF2 | SEHLF2 | Recovered |
| Metric Tons Processed | 506 | 320.1 | 131.5 | — |
| Free Arginine Produced | 53.5 | 8.2 | 39 | — |
| (kg) | | | | |
| Free Arginine Recovered | — | 16 | 73 | 89 |
| (% of feed) | | | | |
| Total Arginine Produced | 2,187 | 853 | 1,173 | — |
| (kg) | | | | |
| Total Arginine | — | 39 | 54 | 93 |
| Recovered (% of feed) | | | | |

The analysis for asparagine and aspartate is reported in Table 3C(1) and total aparagine and aspartate in Table 3C(2) below.

TABLE 3C(1)
Free Asparagine and Asparatate

Free
Asparagine

| | |
|---|---|
| ppm | Free Aspartate |

| | | ppm | db | ppm | ppm db |
|---|---|---|---|---|---|
| Farm1 | Average | 289 | 347 | 85 | 102 |
| | Std. Dev. | 36 | 44 | 7 | 8 |
| Farm2 | Average | 236 | 284 | 82 | 98 |
| | Std. Dev. | 8 | 11 | 8 | 9 |
| Farm3 | Average | 290 | 339 | 113 | 132 |
| | Std. Dev. | 31 | 36 | 8 | 9 |
| Corn | Average | 267 | 315 | 95 | 112 |
| | Std. Dev. | 24 | 29 | 5 | 6 |
| LLF1 | Average | 81 | 95 | 57 | 67 |
| | Std. Dev. | 8 | 10 | 4 | 4 |
| LLF2 | Average | 71 | 85 | 56 | 67 |
| | Std. Dev. | 11 | 13 | 4 | 5 |
| HLF | Average | 581 | 664 | 162 | 186 |
| | Std. Dev. | 45 | 49 | 9 | 11 |
| White | Average | 774 | 855 | 209 | 231 |
| Flake | Std. Dev. | 62 | 70 | 17 | 19 |
| SEHLF1 | Average | 725 | 818 | 223 | 252 |
| | Std. Dev. | 15 | 16 | 6 | 7 |
| SEHLF2 | Average | 708 | 826 | 198 | 231 |
| | Std. Dev. | 54 | 59 | 9 | 10 |
| SEHLF3 | Average | — | — | — | — |
| | Std. Dev. | — | — | — | — |

TABLE 3C(2)
Total Asparagine + Aspartate

Total Asparagine +
Aspartate

| | | ppm | ppm db |
|---|---|---|---|
| Farm1 | Average | 4,632 | 5,548 |
| | Std. Dev. | 250 | 274 |
| Farm2 | Average | 4,892 | 5,868 |
| | Std. Dev. | 75 | 98 |
| Farm3 | Average | 4,575 | 5,349 |
| | Std. Dev. | 58 | 75 |
| Corn | Average | 4,781 | 5,642 |
| | Std. Dev. | 196 | 247 |
| LLF1 | Average | 3,709 | 4,377 |
| | Std. Dev. | 207 | 248 |
| LLF2 | Average | 3,588 | 4,286 |
| | Std. Dev. | 135 | 174 |
| HLF | Average | 7,363 | 8,416 |
| | Std. Dev. | 538 | 631 |
| White | Average | 8,393 | 9,293 |
| Flake | Std. Dev. | 1,905 | 2,083 |
| SEHLF1 | Average | 7,966 | 8,980 |
| | Std. Dev. | 264 | 290 |
| SEHLF2 | Average | 8,807 | 10,278 |
| | Std. Dev. | 409 | 504 |
| SEHLF3 | Average | — | 7,610 |
| | Std. Dev. | — | 526 |

The analysis for total asparagine was repeated and the results are reported in Table 3C(3) below.

TABLE 3C(3)

Total Asparagine

| | | ppm | ppm db |
|---|---|---|---|
| Corn | 1 sample | 4,900 | 5,865 |
| LLF1 | 1 sample | 3,900 | 4,688 |
| LLF2 | 1 sample | 3,900 | 4,720 |
| HLF | 1 sample | 7,900 | 9,288 |
| SEHLF2 | Average | 8,509 | 9,982 |
| | Std. Dev. | 266 | 356 |

Total asparagine recovery is shown in Table 3C(4).

TABLE 3C(4)

| | | | | Total |
|---|---|---|---|---|
| | Corn | LLF2 | SEHLF2 | Recovered |
| Metric Tons Processed | 506 | 320.1 | 131.5 | — |
| Free Asparagine | 135.1 | 25.9 | 92.9 | — |
| Produced (kg) | | | | |
| Free Asparagine | — | 19 | 69 | 88 |
| Recovered (% of feed) | | | | |
| Total Asparagine | 2,420 | 1,188 | 1,158 | — |
| Produced (kg) | | | | |
| Total Asparagine | — | 49 | 48 | 97 |
| Recovered (% of feed) | | | | |

The analysis for total cysteine is reported in Table 3D below.

TABLE 3D

Total Cysteine

| | | ppm | ppm db |
|---|---|---|---|
| Corn | 1 sample | 1,900 | 2,274 |
| LLF1 | 1 sample | 1,700 | 2,043 |
| LLF2 | 1 sample | 1,800 | 2,179 |
| HLF | 1 sample | 2,400 | 2,803 |
| SEHLF2 | Average | 2,482 | 2,911 |
| | Std. Dev. | 98 | 121 |
| SEHLF3 | Average | — | 2,107 |
| | Std. Dev. | — | 195 |

The analysis for free glutamate and glutamine is reported in Table 3E(1) below and the analysis for total glutamate+glutamine is reported in Table 3E(2) below.

TABLE 3E(1)
Free Glutamate and Glutamine

| | |
|---|---|
| Free Glutamate | Free Glutamine |

| | | ppm | ppm db | ppm | ppm db |
|---|---|---|---|---|---|
| Farm1 | Average | 136 | 163 | 15 | 18 |
| | Std. Dev. | 12 | 15 | 3 | 4 |
| Farm2 | Average | 120 | 144 | 21 | 26 |
| | Std. Dev. | 18 | 21 | 8 | 10 |
| Farm3 | Average | 246 | 288 | 22 | 26 |
| | Std. Dev. | 13 | 15 | 2 | 2 |
| Corn | Average | 187 | 220 | 20 | 24 |
| | Std. Dev. | 18 | 20 | 3 | 4 |
| LLF1 | Average | 56 | 66 | 10 | 12 |
| | Std. Dev. | 12 | 13 | 2 | 3 |
| LLF2 | Average | 43 | 52 | 9 | 10 |
| | Std. Dev. | 8 | 9 | 2 | 3 |
| HLF | Average | 458 | 523 | 31 | 35 |
| | Std. Dev. | 73 | 81 | 6 | 7 |
| White | Average | 607 | 670 | 59 | 65 |
| Flake | Std. Dev. | 38 | 44 | 5 | 5 |
| SEHLF1 | Average | 514 | 580 | 32 | 36 |
| | Std. Dev. | 21 | 21 | 2 | 2 |
| SEHLF2 | Average | 552 | 644 | 27 | 32 |
| | Std. Dev. | 26 | 26 | 2 | 2 |
| SEHLF3 | Average | — | — | — | — |
| | Std. Dev. | — | — | — | — |

TABLE 3E(2)
Total Glutamate + Glutamine

Total Glutamate +
Glutamine

| | | ppm | ppm db |
|---|---|---|---|
| Farm1 | Average | 14,244 | 17,036 |
| | Std. Dev. | 1,007 | 1,119 |
| Farm2 | Average | 15,391 | 18,462 |
| | Std. Dev. | 444 | 576 |
| Farm3 | Average | 14,140 | 16,533 |
| | Std. Dev. | 289 | 360 |
| Corn | Average | 14,783 | 17,445 |
| | Std. Dev. | 748 | 932 |
| LLF1 | Average | 14,042 | 16,571 |
| | Std. Dev. | 670 | 834 |
| LLF2 | Average | 13,925 | 16,633 |
| | Std. Dev. | 434 | 581 |
| HLF | Average | 15,613 | 17,847 |
| | Std. Dev. | 945 | 1,106 |
| White | Average | 18,345 | 20,310 |
| Flake | Std. Dev. | 4,211 | 4,608 |
| SEHLF1 | Average | 17,434 | 19,653 |
| | Std. Dev. | 440 | 491 |
| SEHLF2 | Average | 19,075 | 22,260 |
| | Std. Dev. | 773 | 904 |
| SEHLF3 | Average | — | 16,410 |
| | Std. Dev. | — | 1,154 |

The analysis for total glutamate+glutamine was repeated and the results are reported in Table 3E(3) below.

TABLE 3E(3)

Total Glutamate +
Glutamine

| | | ppm | ppm db |
|---|---|---|---|
| Corn | 1 sample | 13,800 | 16,519 |
| LLF1 | 1 sample | 13,600 | 16,346 |
| LLF2 | 1 sample | 14,000 | 16,945 |
| HLF | 1 sample | 15,300 | 17,872 |
| SEHLF2 | Average | 16,664 | 19,547 |
| | Std. Dev. | 347 | 485 |

Total glutamate and glutamine recovery is shown in Table 3E(4).

TABLE 3E(4)

| | | | | Total |
|---|---|---|---|---|
| | Corn | LLF2 | SEHLF2 | Recovered |
| Metric Tons Processed | 506 | 320.1 | 131.5 | — |
| Free Glutamate Produced | 94.3 | 18.1 | 72.6 | — |
| (kg) | | | | |
| Free Glutamate | — | 19 | 77 | 96 |
| Recovered (% of feed) | | | | |
| Free Glutamine | 10 | 3.2 | 3.6 | — |
| Produced (kg) | | | | |
| Free Glutamine | — | 32 | 36 | 68 |
| Recovered (% of feed) | | | | |
| Total Glutamine + | 7,483 | 4,497 | 2,509 | — |
| Glutamate Produced (kg) | | | | |
| Total Glutamine + | — | 60 | 34 | 94 |
| Glutamate Recovered (% | | | | |
| of feed) | | | | |

The analysis for glycine is reported in Table 3F(1) below.

TABLE 3F(1)
Glycine

| | | Free Glycine | | Total Glycine | |
|---|---|---|---|---|---|
| | | ppm | ppm db | ppm | ppm db |
| Farm1 | Average | 23 | 28 | 3,131 | 3,751 |
| | Std. Dev. | 2 | 2 | 153 | 165 |
| Farm2 | Average | 25 | 30 | 3,262 | 3,913 |
| | Std. Dev. | 1 | 1 | 21 | 23 |
| Farm3 | Average | 21 | 25 | 3,110 | 3,636 |
| | Std. Dev. | 3 | 3 | 98 | 116 |
| Corn | Average | 22 | 26 | 3,289 | 3,881 |
| | Std. Dev. | 2 | 2 | 80 | 102 |
| LLF1 | Average | 14 | 17 | 2,224 | 2,625 |
| | Std. Dev. | 1 | 2 | 110 | 134 |
| LLF2 | Average | 12 | 15 | 2,128 | 2,542 |
| | Std. Dev. | 1 | 2 | 57 | 73 |
| HLF | Average | 67 | 77 | 5,304 | 6,062 |
| | Std. Dev. | 6 | 7 | 403 | 465 |
| White | Average | 44 | 49 | 6,165 | 6,827 |
| Flake | Std. Dev. | 2 | 3 | 1,382 | 1,515 |
| SEHLF1 | Average | 45 | 50 | 5,679 | 6,402 |
| | Std. Dev. | 2 | 2 | 220 | 254 |
| SEHLF2 | Average | 44 | 51 | 6,277 | 7,325 |
| | Std. Dev. | 1 | 2 | 296 | 338 |
| SEHLF3 | Average | — | — | — | 5,160 |
| | Std. Dev. | — | — | — | 337 |

The analysis for total glycine was repeated and the results are reported in Table 3F(2) below.

TABLE 3F(2)

Total Glycine

| | | ppm | ppm db |
|---|---|---|---|
| Corn | 1 sample | 3,300 | 3,950 |
| LLF1 | 1 sample | 2,300 | 2,764 |
| LLF2 | 1 sample | 2,300 | 2,784 |
| HLF | 1 sample | 5,700 | 6,658 |
| SEHLF2 | Average | 6,073 | 7,124 |
| | Std. Dev. | 142 | 213 |

Total glycine recovery is shown in Table 3F(3).

TABLE 3F(3)

| | | | | Total |
|---|---|---|---|---|
| | Corn | LLF2 | SEHLF2 | Recovered |
| Metric Tons Processed | 506 | 320.1 | 131.5 | — |
| Free Glycine Produced | 11.3 | 4.5 | 5.9 | — |
| (kg) | | | | |
| Free Glycine Recovered | — | 40 | 52 | 92 |
| (% of feed) | | | | |
| Total Glycine Produced | 1,665 | 712 | 826 | — |
| (kg) | | | | |
| Total Glycine Recovered | — | 43 | 50 | 92 |
| (% of feed) | | | | |

The analysis for histidine is reported in Table 3G(1) below.

TABLE 3G(1)
Histidine

| | | Free Histidine | | Total Histidine | |
|---|---|---|---|---|---|
| | | ppm | ppm db | ppm | ppm db |
| Farm1 | Average | 53 | 64 | 2,150 | 2,575 |
| | Std. Dev. | 9 | 11 | 277 | 324 |
| Farm2 | Average | 51 | 62 | 2,392 | 2,869 |
| | Std. Dev. | 5 | 7 | 55 | 68 |
| Farm3 | Average | 62 | 73 | 2,284 | 2,670 |
| | Std. Dev. | 8 | 9 | 34 | 39 |
| Corn | Average | 49 | 58 | 2,139 | 2,524 |
| | Std. Dev. | 3 | 4 | 299 | 355 |
| LLF1 | Average | 17 | 20 | 1,862 | 2,197 |
| | Std. Dev. | 2 | 3 | 108 | 128 |
| LLF2 | Average | 15 | 17 | 1,792 | 2,140 |
| | Std. Dev. | 2 | 2 | 68 | 82 |
| HLF | Average | 99 | 113 | 3,010 | 3,441 |
| | Std. Dev. | 8 | 9 | 158 | 191 |
| White | Average | 140 | 155 | 3,394 | 3,758 |
| Flake | Std. Dev. | 8 | 10 | 809 | 885 |
| SEHLF1 | Average | 301 | 339 | 3,444 | 3,883 |
| | Std. Dev. | 15 | 15 | 107 | 123 |
| SEHLF2 | Average | 208 | 243 | 3,616 | 4,221 |
| | Std. Dev. | 15 | 16 | 211 | 262 |
| SEHLF3 | Average | — | — | — | 3,180 |
| | Std. Dev. | — | — | — | 298 |

The analysis for total histidine was repeated and the results are reported in Table 3G(2) below.

TABLE 3G(2)

Total Histidine

| | | ppm | ppm db |
|---|---|---|---|
| Corn | 1 sample | 2,400 | 2,873 |
| LLF1 | 1 sample | 2,100 | 2,524 |
| LLF2 | 1 sample | 2,100 | 2,542 |
| HLF | 1 sample | 3,300 | 3,855 |
| SEHLF2 | Average | 3,491 | 4,095 |
| | Std. Dev. | 94 | 124 |

Total histidine recovery is shown in Table 3G(3).

TABLE 3G(3)

| | | | | Total |
|---|---|---|---|---|
| | Corn | LLF2 | SEHLF2 | Recovered |
| Metric Tons Processed | 506 | 320.1 | 131.5 | — |
| Free Histidine Produced | 24.9 | 5.4 | 27.2 | — |
| (kg) | | | | |
| Free Histidine | — | 22 | 110 | 133 |
| Recovered (% of feed) | | | | |
| Total Histidine | 1,083 | 596 | 476 | — |
| Produced (kg) | | | | |
| Total Histidine | — | 55 | 44 | 99 |
| Recovered (% of feed) | | | | |

The analysis for total hydroxylysine is reported in Table 3H below.

TABLE 3H

Total
Hydroxylysine

| | | ppm | ppm db |
|---|---|---|---|
| Corn | 1 sample | 100 | 120 |
| LLF1 | 1 sample | 100 | 120 |
| LLF2 | 1 sample | 100 | 121 |
| HLF | 1 sample | 300 | 350 |
| SEHLF2 | Average | 300 | 352 |
| | Std. Dev. | 0 | 3 |
| SEHLF3 | Average | — | 303 |
| | Std. Dev. | — | 41 |

The analysis for total hydroxyproline is reported in Table 31 below.

TABLE 3I

Total
Hydroxyproline

| | | ppm | ppm db |
|---|---|---|---|
| Corn | 1 sample | 100 | 120 |
| LLF1 | 1 sample | 0 | 0 |
| LLF2 | 1 sample | 0 | 0 |
| HLF | 1 sample | 300 | 350 |
| SEHLF2 | Average | 309 | 362 |
| | Std. Dev. | 30 | 34 |
| SEHLF3 | Average | — | 604 |
| | Std. Dev. | — | 291 |

The analysis for isoleucine is reported in Table 3J(1) below.

TABLE 3J(1)
Isoleucine

| | | Free Isoleucine | | Total Isoleucine | |
|---|---|---|---|---|---|
| | | ppm | ppm db | ppm | ppm db |
| Farm1 | Average | 16 | 19 | 2,638 | 3,160 |
| | Std. Dev. | 5 | 5 | 131 | 141 |
| Farm2 | Average | 16 | 20 | 2,770 | 3,323 |
| | Std. Dev. | 4 | 5 | 84 | 106 |
| Farm3 | Average | 19 | 23 | 2,650 | 3,099 |
| | Std. Dev. | 2 | 2 | 68 | 82 |
| Corn | Average | 15 | 18 | 2,726 | 3,217 |
| | Std. Dev. | 1 | 2 | 161 | 201 |
| LLF1 | Average | 8 | 9 | 2,477 | 2,923 |
| | Std. Dev. | 1 | 1 | 166 | 200 |
| LLF2 | Average | 7 | 9 | 2,423 | 2,895 |
| | Std. Dev. | 1 | 1 | 92 | 116 |
| HLF | Average | 21 | 24 | 3,219 | 3,679 |
| | Std. Dev. | 4 | 4 | 282 | 328 |
| White | Average | 23 | 26 | 3,731 | 4,132 |
| Flake | Std. Dev. | 1 | 1 | 853 | 936 |
| SEHLF1 | Average | 36 | 40 | 3,660 | 4,126 |
| | Std. Dev. | 2 | 3 | 173 | 197 |
| SEHLF2 | Average | 22 | 25 | 3,892 | 4,541 |
| | Std. Dev. | 1 | 1 | 328 | 377 |
| SEHLF3 | Average | — | — | — | 3,657 |
| | Std. Dev. | — | — | — | 319 |

The analysis for total isoleucine was repeated and the results are reported in Table 3J(2) below.

TABLE 3J(2)

Total Isoleucine

| | | ppm | ppm db |
|---|---|---|---|
| Corn | 1 sample | 2,700 | 3,232 |
| LLF1 | 1 sample | 2,500 | 3,005 |
| LLF2 | 1 sample | 2,600 | 3,147 |
| HLF | 1 sample | 3,400 | 3,971 |
| SEHLF2 | Average | 3,527 | 4,137 |
| | Std. Dev. | 149 | 179 |

Total isoleucine recovery is shown in Table 3J(3).

TABLE 3J(3)

| | | | | Total |
|---|---|---|---|---|
| | Corn | LLF2 | SEHLF2 | Recovered |
| Metric Tons Processed | 506 | 320.1 | 131.5 | — |
| Free Isoleucine | 7.7 | 2.7 | 2.7 | — |
| Produced (kg) | | | | |
| Free Isoleucine | — | 33 | 38 | 71 |
| Recovered (% of feed) | | | | |
| Total Isoleucine | 1,380 | 793 | 512 | — |
| Produced (kg) | | | | |
| Total Isoleucine | — | 57 | 37 | 95 |
| Recovered (% of feed) | | | | |

The analysis for total lanthionine is reported in Table 3K below.

TABLE 3K

Total Lanthionine

| | | ppm | ppm db |
|---|---|---|---|
| Corn | 1 sample | 300 | 359 |
| LLF1 | 1 sample | 0 | 0 |
| LLF2 | 1 sample | 0 | 0 |
| HLF | 1 sample | 200 | 234 |
| SEHLF2 | Average | 255 | 300 |
| | Std. Dev. | 151 | 178 |

The analysis for leucine is reported in Table 3L(1) below.

TABLE 3L(1)
Leucine

| | | Free Leucine | | Total Leucine | |
|---|---|---|---|---|---|
| | | ppm | ppm db | ppm | ppm db |
| Farm1 | Average | 15 | 18 | 8,502 | 10,182 |
| | Std. Dev. | 2 | 3 | 701 | 787 |
| Farm2 | Average | 17 | 21 | 9,139 | 10,962 |
| | Std. Dev. | 5 | 6 | 269 | 347 |
| Farm3 | Average | 18 | 21 | 8,415 | 9,839 |
| | Std. Dev. | 2 | 2 | 247 | 299 |
| Corn | Average | 18 | 21 | 8,940 | 10,550 |
| | Std. Dev. | 1 | 2 | 491 | 608 |
| LLF1 | Average | 10 | 11 | 9,074 | 10,708 |
| | Std. Dev. | 2 | 2 | 443 | 554 |
| LLF2 | Average | 8 | 10 | 9,062 | 10,824 |
| | Std. Dev. | 1 | 1 | 272 | 361 |
| HLF | Average | 30 | 35 | 8,235 | 9,414 |
| | Std. Dev. | 18 | 20 | 632 | 737 |
| White | Average | 29 | 33 | 9,415 | 10,425 |
| Flake | Std. Dev. | 3 | 3 | 2,108 | 2,308 |
| SEHLF1 | Average | 35 | 39 | 8,870 | 9,999 |
| | Std. Dev. | 5 | 6 | 226 | 250 |
| SEHLF2 | Average | 27 | 31 | 9,908 | 11,560 |
| | Std. Dev. | 2 | 3 | 552 | 610 |
| SEHLF3 | Average | — | — | — | 9,887 |
| | Std. Dev. | — | — | — | 797 |

The analysis for total leucine was repeated and the results are reported in Table 3L(2) below.

TABLE 3L(2)

Total Leucine

| | | ppm | ppm db |
|---|---|---|---|
| Corn | 1 sample | 9,100 | 10,893 |
| LLF1 | 1 sample | 9,400 | 11,298 |
| LLF2 | 1 sample | 10,000 | 12,104 |
| HLF | 1 sample | 8,900 | 10,396 |
| SEHLF2 | Average | 9,591 | 11,250 |
| | Std. Dev. | 202 | 259 |

Total leucine recovery is shown in Table 3L(3).

TABLE 3L(3)

| | | | | Total |
|---|---|---|---|---|
| | Corn | LLF2 | SEHLF2 | Recovered |
| Metric Tons Processed | 506 | 320.1 | 131.5 | — |
| Free Leucine Produced | 9.1 | 3.2 | 3.6 | — |
| (kg) | | | | |
| Free Leucine Recovered | — | 34 | 38 | 72 |
| (% of feed) | | | | |
| Total Leucine Produced | 4,525 | 2,906 | 1,303 | — |
| (kg) | | | | |
| Total Leucine Recovered | — | 64 | 29 | 93 |
| (% of feed) | | | | |

The analysis for methionine is reported in Table 3M(1) below.

TABLE 3M(1)
Methionine

| | | Free | | | |
|---|---|---|---|---|---|
| | | Methionine | | Total Methionine | |
| | | ppm | ppm db | ppm | ppm db |
| Farm1 | Average | 11 | 13 | — | — |
| | Std. Dev. | 3 | 3 | — | — |
| Farm2 | Average | 12 | 14 | — | — |
| | Std. Dev. | 2 | 3 | — | — |
| Farm3 | Average | 13 | 16 | — | — |
| | Std. Dev. | 2 | 2 | — | — |
| Corn | Average | 12 | 14 | 1,508 | 1,779 |
| | Std. Dev. | 2 | 2 | 74 | 94 |
| LLF1 | Average | 7 | 8 | 1,399 | 1,651 |
| | Std. Dev. | 1 | 1 | 87 | 107 |
| LLF2 | Average | 6 | 7 | 1,337 | 1,597 |
| | Std. Dev. | 1 | 1 | 75 | 89 |
| HLF | Average | 13 | 15 | 1,718 | 1,964 |
| | Std. Dev. | 3 | 4 | 154 | 181 |
| White | Average | 4 | 15 | 1,983 | 2,195 |
| Flake | Std. Dev. | 1 | 1 | 441 | 483 |
| SEHLF1 | Average | 23 | 26 | — | — |
| | Std. Dev. | 2 | 2 | — | — |
| SEHLF2 | Average | 12 | 14 | 2,098 | 2,448 |
| | Std. Dev. | 1 | 1 | 174 | 196 |
| SEHLF3 | Average | — | — | — | 1,970 |
| | Std. Dev. | — | — | — | 197 |

The analysis for total methionine was repeated and the results are reported in Table 3M(2) below.

TABLE 3M(2)

Total Methionine

| | | ppm | ppm db |
|---|---|---|---|
| Corn | 1 sample | 1,800 | 2,155 |
| LLF1 | 1 sample | 1,700 | 2,043 |
| LLF2 | 1 sample | 1,800 | 2,179 |
| HLF | 1 sample | 2,300 | 2,687 |
| SEHLF2 | Average | 2,427 | 2,848 |
| | Std. Dev. | 110 | 146 |

Total methionine recovery is shown in Table 3M(3).

TABLE 3M(3)

| | | | | Total |
|---|---|---|---|---|
| | Corn | LLF2 | SEHLF2 | Recovered |
| Metric Tons Processed | 506 | 320.1 | 131.5 | — |
| Free Methionine | 5.9 | 2.3 | 1.8 | — |
| Produced (kg) | | | | |
| Free Methionine | — | 36 | 28 | 64 |
| Recovered (% of feed) | | | | |
| Total Methionine | 763 | 448 | 276 | — |
| Produced (kg) | | | | |
| Total Methionine | — | 59 | 36 | 95 |
| Recovered (% of feed) | | | | |

The analysis for total ornithine is reported in Table 3N below.

TABLE 3N

Total Ornithine

| | | ppm | ppm db |
|---|---|---|---|
| Corn | 1 sample | 0 | 0 |
| LLF1 | 1 sample | 0 | 0 |
| LLF2 | 1 sample | 0 | 0 |
| HLF | 1 sample | 100 | 117 |
| SEHLF2 | Average | 100 | 117 |
| | Std. Dev. | 0 | 1 |

The analysis for phenylalanine is reported in Table 3O(1) below.

TABLE 3O(1)
Phenylalanine

| | | Free | | Total | |
|---|---|---|---|---|---|
| | | Phenylalanine | | Phenylalanine | |
| | | ppm | ppm db | ppm | ppm db |
| Farm1 | Average | 15 | 18 | 2,867 | 3,434 |
| | Std. Dev. | 3 | 4 | 192 | 212 |
| Farm2 | Average | 16 | 19 | 3,068 | 3,680 |
| | Std. Dev. | 3 | 4 | 90 | 115 |
| Farm3 | Average | 17 | 20 | 2,841 | 3,321 |
| | Std. Dev. | 2 | 2 | 65 | 79 |
| Corn | Average | 16 | 19 | 3,015 | 3,558 |
| | Std. Dev. | 2 | 2 | 142 | 178 |
| LLF1 | Average | 9 | 11 | 2,854 | 3,367 |
| | Std. Dev. | 1 | 2 | 148 | 180 |
| LLF2 | Average | 8 | 10 | 2,822 | 3,371 |
| | Std. Dev. | 1 | 1 | 81 | 108 |
| HLF | Average | 26 | 29 | 3,437 | 3,929 |
| | Std. Dev. | 8 | 9 | 246 | 289 |
| White | Average | 27 | 29 | 3,863 | 4,277 |
| Flake | Std. Dev. | 1 | 1 | 864 | 945 |
| SEHLF1 | Average | 33 | 37 | 3,689 | 4,159 |
| | Std. Dev. | 3 | 3 | 121 | 134 |
| SEHLF2 | Average | 25 | 29 | 4,127 | 4,816 |
| | Std. Dev. | 1 | 1 | 226 | 260 |
| SEHLF3 | Average | — | — | — | 4,637 |
| | Std. Dev. | — | — | — | 365 |

The analysis for total phenylalanine was repeated and the results are reported in Table 3O(2) below.

TABLE 3O(2)

Total Phenylalanine

| | | ppm | ppm db |
|---|---|---|---|
| Corn | 1 sample | 3,600 | 4,309 |
| LLF1 | 1 sample | 3,500 | 4,207 |
| LLF2 | 1 sample | 3,600 | 4,357 |
| HLF | 1 sample | 4,300 | 5,023 |
| SEHLF2 | Average | 4,609 | 5,406 |
| | Std. Dev. | 114 | 149 |

Total phenylalanine recovery is shown in Table 3O(3).

TABLE 3O(3)

| | | | | Total |
|---|---|---|---|---|
| | Corn | LLF2 | SEHLF2 | Recovered |
| Metric Tons Processed | 506 | 320.1 | 131.5 | — |
| Free Phenylalanine | 8.2 | 2.7 | 3.2 | — |
| Produced (kg) | | | | |
| Free Phenylalanine | — | 35 | 41 | 76 |
| Recovered (% of feed) | | | | |
| Total Phenylalanine | 1,526 | 914 | 543 | — |
| Produced (kg) | | | | |
| Total Phenylalanine | — | 60 | 36 | 95 |
| Recovered (% of feed) | | | | |

The analysis for total proline is reported in Table 3P below.

TABLE 3P

Total Proline

| | | ppm | ppm db |
|---|---|---|---|
| Corn | 1 sample | 7,000 | 8,379 |
| LLF1 | 1 sample | 6,800 | 8,173 |
| LLF2 | 1 sample | 6,800 | 8,230 |
| HLF | 1 sample | 7,400 | 8,644 |
| SEHLF2 | Average | 7,718 | 9,053 |
| | Std. Dev. | 160 | 209 |
| SEHLF3 | Average | — | 7,623 |
| | Std. Dev. | — | 667 |

The analysis for serine is reported in Table 3Q(1) below.

TABLE 3Q(1)
Serine

| | | Free Serine | | Total Serine | |
|---|---|---|---|---|---|
| | | ppm | ppm db | ppm | ppm db |
| Farm1 | Average | 26 | 31 | 3,413 | 4,088 |
| | Std. Dev. | 3 | 4 | 234 | 262 |
| Farm2 | Average | 27 | 32 | 3,655 | 4,384 |
| | Std. Dev. | 3 | 4 | 85 | 113 |
| Farm3 | Average | 29 | 34 | 3,356 | 3,924 |
| | Std. Dev. | 4 | 5 | 79 | 99 |
| Corn | Average | 27 | 32 | 3,584 | 4,230 |
| | Std. Dev. | 2 | 2 | 131 | 160 |
| LLF1 | Average | 13 | 16 | 3,068 | 3,620 |
| | Std. Dev. | 1 | 1 | 137 | 172 |
| LLF2 | Average | 11 | 14 | 3,030 | 3,619 |
| | Std. Dev. | 1 | 2 | 140 | 168 |
| HLF | Average | 55 | 63 | 4,417 | 5,049 |
| | Std. Dev. | 5 | 6 | 318 | 372 |
| White | Average | 62 | 69 | 5,060 | 5,603 |
| Flake | Std. Dev. | 3 | 3 | 1,144 | 1,253 |
| SEHLF1 | Average | 62 | 70 | 4,725 | 5,327 |
| | Std. Dev. | 3 | 3 | 164 | 188 |
| SEHLF2 | Average | 58 | 68 | 5,134 | 5,991 |
| | Std. Dev. | 4 | 4 | 317 | 365 |
| SEHLF3 | Average | — | — | — | 4,157 |
| | Std. Dev. | — | — | — | 335 |

The analysis for total serine was repeated and the results are reported in Table 3Q(2) below.

TABLE 3Q(2)

Total Serine

| | | ppm | ppm db |
|---|---|---|---|
| Corn | 1 sample | 3,300 | 3,950 |
| LLF1 | 1 sample | 2,800 | 3,365 |
| LLF2 | 1 sample | 3,000 | 3,631 |
| HLF | 1 sample | 4,300 | 5,023 |
| SEHLF2 | Average | 4,645 | 5,449 |
| | Std. Dev. | 144 | 187 |

Total serine recovery is shown in Table 3Q(3).

TABLE 3Q(3)

| | | | | Total |
|---|---|---|---|---|
| | Corn | LLF2 | SEHLF2 | Recovered |
| Metric Tons Processed | 506 | 320.1 | 131.5 | — |
| Free Serine Produced (kg) | 13.6 | 4.1 | 7.7 | — |
| Free Serine Recovered (% of | — | 31 | 56 | 87 |
| feed) | | | | |
| Total Serine Produced (kg) | 1,814 | 982 | 675 | — |
| Total Serine Recovered (% of | — | 54 | 37 | 91 |
| feed) | | | | |

The analysis for total taurine is reported in Table 3R below.

TABLE 3R

Total Taurine

| | | ppm | ppm db |
|---|---|---|---|
| Corn | 1 sample | 400 | 479 |
| LLF1 | 1 sample | 300 | 361 |
| LLF2 | 1 sample | 300 | 363 |
| HLF | 1 sample | 400 | 467 |
| SEHLF2 | Average | 491 | 576 |
| | Std. Dev. | 30 | 37 |
| SEHLF3 | Average | — | 573 |
| | Std. Dev. | — | 101 |

The analysis for threonine is reported in Table 3S(1) below.

TABLE 3S(1)
Threonine

| | | Free Threonine | | Total Threonine | |
|---|---|---|---|---|---|
| | | ppm | ppm db | ppm | ppm db |
| Farm1 | Average | 12 | 15 | 2,697 | 3,231 |
| | Std. Dev. | 3 | 3 | 140 | 155 |
| Farm2 | Average | 14 | 16 | 2,872 | 3,445 |
| | Std. Dev. | 2 | 3 | 93 | 120 |
| Farm3 | Average | 15 | 17 | 2,701 | 3,158 |
| | Std. Dev. | 2 | 3 | 28 | 38 |
| Corn | Average | 14 | 17 | 2,724 | 3,215 |
| | Std. Dev. | 2 | 2 | 96 | 120 |
| LLF1 | Average | 8 | 9 | 2,186 | 2,580 |
| | Std. Dev. | 1 | 1 | 108 | 130 |
| LLF2 | Average | 7 | 9 | 2,128 | 2,542 |
| | Std. Dev. | 1 | 1 | 87 | 111 |
| HLF | Average | 20 | 23 | 3,623 | 4,142 |
| | Std. Dev. | 3 | 4 | 268 | 314 |
| White | Average | 22 | 24 | 4,213 | 4,665 |
| Flake | Std. Dev. | 1 | 2 | 954 | 1,043 |
| SEHLF1 | Average | 29 | 32 | 4,265 | 4,807 |
| | Std. Dev. | 2 | 2 | 93 | 100 |
| SEHLF2 | Average | 21 | 24 | 4,280 | 4,994 |
| | Std. Dev. | 2 | 2 | 204 | 238 |
| SEHLF3 | Average | — | — | — | 3,740 |
| | Std. Dev. | — | — | — | 253 |

The analysis for total threonine was repeated and the results are reported in Table 3S(2) below.

TABLE 3S(2)

Total Threonine

| | | ppm | ppm db |
|---|---|---|---|
| Corn | 1 sample | 2,700 | 3,232 |
| LLF1 | 1 sample | 2,200 | 2,644 |
| LLF2 | 1 sample | 2,300 | 2,784 |
| HLF | 1 sample | 4,000 | 4,672 |
| SEHLF2 | Average | 4,300 | 5,044 |
| | Std. Dev. | 89 | 136 |

Total threonine recovery is shown in Table 3S(3).

TABLE 3S(3)

| | | | | Total |
|---|---|---|---|---|
| | Corn | LLF2 | SEHLF2 | Recovered |
| Metric Tons Processed | 506 | 320.1 | 131.5 | — |
| Free Threonine Produced (kg) | 7.3 | 2.7 | 2.7 | — |
| Free Threonine Recovered (% of | — | 36 | 39 | 75 |
| feed) | | | | |
| Total Threonine Produced (kg) | 1,379 | 700 | 563 | — |
| Total Threonine Recovered (% | — | 51 | 41 | 92 |
| of feed) | | | | |

The analysis for tryptophan is reported in Table 3T(1) below.

TABLE 3T(1)
Tryptophan

Free Tryptophan

| | | ppm | ppm db |
|---|---|---|---|
| Farm1 | Average | 21 | 25 |
| | Std. Dev. | 3 | 4 |
| Farm2 | Average | 21 | 25 |
| | Std. Dev. | 3 | 4 |
| Farm3 | Average | 23 | 26 |
| | Std. Dev. | 3 | 3 |
| Corn | Average | 21 | 25 |
| | Std. Dev. | 2 | 2 |
| LLF1 | Average | 9 | 11 |
| | Std. Dev. | 1 | 1 |
| LLF2 | Average | 9 | 11 |
| | Std. Dev. | 1 | 1 |
| HLF | Average | 32 | 36 |
| | Std. Dev. | 3 | 4 |
| White | Average | 36 | 40 |
| Flake | Std. Dev. | 2 | 2 |
| SEHLF1 | Average | 41 | 46 |
| | Std. Dev. | 2 | 2 |
| SEHLF2 | Average | 32 | 37 |
| | Std. Dev. | 1 | 1 |

The analysis for total tryptophan was repeated and the results are reported in Table 3T(2) below.

TABLE 3T(2)

Total Tryptophan

| | | ppm | ppm db |
|---|---|---|---|
| Corn | 1 sample | 700 | 838 |
| LLF1 | 1 sample | 500 | 601 |
| LLF2 | 1 sample | 500 | 605 |
| HLF | 1 sample | 800 | 934 |
| SEHLF2 | Average | 1,227 | 1,440 |
| | Std. Dev. | 47 | 59 |
| SEHLF3 | Average | — | 830 |
| | Std. Dev. | — | 79 |

Total tryptophan recovery is shown in Table 3T(3).

TABLE 3T(3)

| | Corn | LLF2 | SEHLF2 | Total Recov. |
|---|---|---|---|---|
| Metric Tons Processed | 506 | 320.1 | 131.5 | — |
| Free Tryptophan | 10.9 | 3.2 | 4.1 | — |
| Produced (kg) | | | | |
| Free Tryptophan | — | 28 | 39 | 68 |
| Recovered (% of feed) | | | | |

The analysis for tyrosine is reported in Table 3U(1) below.

TABLE 3U(1)
Tyrosine

| | | Free Tyrosine | | Total Tyrosine | |
|---|---|---|---|---|---|
| | | ppm | ppm db | ppm | ppm db |
| Farm1 | Average | 44 | 52 | 3,061 | 3,667 |
| | Std. Dev. | 5 | 7 | 175 | 192 |
| Farm2 | Average | 43 | 51 | 3,248 | 3,896 |
| | Std. Dev. | 4 | 5 | 32 | 41 |
| Farm3 | Average | 48 | 56 | 2,990 | 3,496 |
| | Std. Dev. | 5 | 6 | 78 | 95 |
| Corn | Average | 46 | 54 | 3,205 | 3,782 |
| | Std. Dev. | 3 | 4 | 165 | 210 |
| LLF1 | Average | 21 | 24 | 3,106 | 3,665 |
| | Std. Dev. | 3 | 3 | 191 | 229 |
| LLF2 | Average | 19 | 22 | 3,048 | 3,641 |
| | Std. Dev. | 2 | 2 | 119 | 155 |
| HLF | Average | 79 | 91 | 3,583 | 4,095 |
| | Std. Dev. | 6 | 7 | 282 | 332 |
| White | Average | 100 | 111 | 3,922 | 4,343 |
| Flake | Std. Dev. | 5 | 6 | 872 | 955 |
| SEHLF1 | Average | 112 | 127 | 3,800 | 4,284 |
| | Std. Dev. | 12 | 13 | 117 | 127 |
| SEHLF2 | Average | 116 | 135 | 4,238 | 4,945 |
| | Std. Dev. | 6 | 7 | 311 | 357 |
| SEHLF3 | Average | — | — | — | 2,910 |
| | Std. Dev. | — | — | — | 277 |

The analysis for total tyrosine was repeated and the results are reported in Table 3U(2) below.

TABLE 3U(2)

Total Tyrosine

| | | ppm | ppm db |
|---|---|---|---|
| Corn | 1 sample | 2400 | 2873 |
| LLF1 | 1 sample | 2,200 | 2,644 |
| LLF2 | 1 sample | 2,300 | 2,784 |
| HLF | 1 sample | 2,900 | 3,387 |
| SEHLF2 | Average | 3,036 | 3,562 |
| | Std. Dev. | 81 | 110 |

Total tyrosine recovery is shown in Table 3U(3).

TABLE 3U(3)

| | | | | Total |
|---|---|---|---|---|
| | Corn | LLF2 | SEHLF2 | Recovered |
| Metric Tons Processed | 506 | 320.1 | 131.5 | — |
| Free Tyrosine Produced (kg) | 23.1 | 6.8 | 15.4 | — |
| Free Tyrosine Recovered (% of | — | 29 | 66 | 95 |
| feed) | | | | |
| Total Tyrosine Produced (kg) | 1,622 | 994 | 589 | — |
| Total Tyrosine Recovered (% of | — | 61 | 34 | 96 |
| feed) | | | | |

The analysis for valine is reported in Table 3V(1) below.

TABLE 3V(1)
Valine

| | | Free Valine | | Total Valine | |
|---|---|---|---|---|---|
| | | ppm | ppm db | ppm | ppm db |
| Farm1 | Average | 27 | 33 | 3,650 | 4,372 |
| | Std. Dev. | 5 | 7 | 193 | 209 |
| Farm2 | Average | 32 | 38 | 3,841 | 4,607 |
| | Std. Dev. | 7 | 8 | 68 | 87 |
| Farm3 | Average | 34 | 40 | 3,618 | 4,230 |
| | Std. Dev. | 4 | 5 | 85 | 102 |
| Corn | Average | 31 | 37 | 3,826 | 4,516 |
| | Std. Dev. | 3 | 3 | 188 | 237 |
| LLF1 | Average | 13 | 15 | 3,253 | 3,838 |
| | Std. Dev. | 2 | 2 | 202 | 240 |
| LLF2 | Average | 11 | 13 | 3,151 | 3,763 |
| | Std. Dev. | 1 | 1 | 113 | 138 |
| HLF | Average | 58 | 66 | 5,122 | 5,855 |
| | Std. Dev. | 9 | 10 | 392 | 457 |
| White | Average | 65 | 72 | 5,832 | 6,458 |
| Flake | Std. Dev. | 3 | 3 | 1317 | 1443 |
| SEHLF1 | Average | 78 | 87 | 5,612 | 6,326 |
| | Std. Dev. | 5 | 5 | 277 | 313 |
| SEHLF2 | Average | 61 | 71 | 6,174 | 7,205 |
| | Std. Dev. | 3 | 3 | 437 | 509 |
| SEHLF3 | Average | — | — | — | 5,407 |
| | Std. Dev. | — | — | — | 437 |

The analysis for total valine was repeated and the results are reported in Table 3V(2) below.

TABLE 3V(2)

Total Valine

| | | ppm | ppm db |
|---|---|---|---|
| Corn | 1 sample | 3,800 | 4,549 |
| LLF1 | 1 sample | 3,300 | 3,966 |
| LLF2 | 1 sample | 3,300 | 3,994 |
| HLF | 1 sample | 5,500 | 6,424 |
| SEHLF2 | Average | 5,709 | 6,697 |
| | Std. Dev. | 192 | 238 |

Total valine recovery is shown in Table 3V(3).

TABLE 3V(3)

| | | | | Total |
|---|---|---|---|---|
| | Corn | LLF2 | SEHLF2 | Recovered |
| Metric Tons Processed | 506 | 320.1 | 131.5 | — |
| Free Valine Produced (kg) | 15.9 | 4.1 | 8.2 | — |
| Free Valine Recovered (% of | — | 26 | 51 | 77 |
| feed) | | | | |
| Total Valine Produced (kg) | 1,937 | 1,042 | 812 | — |
| Total Valine Recovered (% of | — | 54 | 42 | 96 |
| feed) | | | | |

The data from Examples 2 and 3 for SEHLF prepared from yellow #2 corn (i.e., “SEHLF3”) and for SEHLF prepared from a corn variety having high oil and high lysine traits (i.e., “SEHLF1” and “SEHLF2”) are summarized in Table 3W where amino acid concentration is reported in weight percent on an anhydrous basis.

TABLE 3W

| Description | SEHLF3 | SEHLF1 and SEHLF2 |
|---|---|---|
| Free lysine | — | 0.33 to 0.35 |
| Total lysine | 0.46 | 0.91 to 1.05 |
| Free alanine | — | 0.23 to 0.25 |
| Total alanine | 0.71 | 0.79 to 0.89 |
| Free arginine | — | 0.32 to 0.35 |
| Total arginine | 0.66 | 0.91 to 1.04 |
| Free asparagine | — | 0.082 to 0.083 |
| Free asparatate | — | 0.023 to 0.025 |
| Total aparagine + asparatate | 0.76 | 0.9 to 1.03 |
| Total cysteine | 0.21 | 0.29 |
| Free glutamine | — | 0.058 to 0.064 |
| Free glutamate | — | 0.003 to 0.004 |
| Total glutamine + glutamate | 1.64 | 1.95 to 2.23 |
| Free glycine | — | 0.05 |
| Total glycine | 0.52 | 0.64 to 0.73 |
| Free histidine | — | 0.024 to 0.034 |
| Total histidine | 0.32 | 0.39 to 0.42 |
| Total hydroxylysine | 0.03 | 0.035 |
| Total hydroxyproline | 0.06 | 0.036 |
| Free isoleucine | — | 0.025 to 0.04 |
| Total isoleucine | 0.37 | 0.41 to 0.45 |
| Free leucine | — | 0.031 to 0.039 |
| Total leucine | 0.99 | 1 to 1.15 |
| Total lanthionine | — | 0.03 |
| Free methionine | — | 0.01 to 0.03 |
| Total methionine | 0.2 | 0.24 to 0.28 |
| Total ornithine | — | 0.01 |
| Free phenylalanine | — | 0.03 to 0.04 |
| Total phenylalanine | 0.46 | 0.42 to 0.54 |
| Total proline | 0.76 | 0.91 |
| Free serine | — | 0.007 |
| Total serine | 0.42 | 0.53 to 0.6 |
| Total taurine | 0.06 | 0.06 |
| Free threonine | — | 0.002 to 0.003 |
| Total threonine | 0.37 | 0.48 to 0.5 |
| Free tryptophan | — | 0.004 to 0.005 |
| Total tryptophan | 0.083 | 0.114 |
| Free tyrosine | — | 0.01 |
| Total tyrosine | 0.29 | 0.36 to 0.49 |
| Free valine | — | 0.007 to 0.008 |
| Total valine | 0.54 | 0.63 to 0.72 |

In view of the above, it will be seen that the several objects of the invention are achieved and other advantageous results attained.

As various changes could be made in the above compositions and processes without departing from the scope of the invention, it is intended that all matter contained in the above description and shown in the accompanying drawings shall be interpreted as illustrative and not in a limiting sense.

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

1. An extracted high lysine corn fraction composition prepared from high lysine corn kernels, the composition comprising starch, protein and oil, and on an anhydrous basis, from about 0.6 to about 2.8 weight percent total lysine.

2. The composition of claim 1 wherein the lysine concentration is from about 0.8 to about 2.8 weight percent.

3-4. (canceled)

5. The composition of claim 1 further comprising tryptophan wherein the total tryptophan concentration, on an anhydrous basis, is from about 0.06 to about 0.22 percent by weight.

6-8. (canceled)

9. The composition of claim 1 wherein the ratio of total lysine to protein is from about 0.03 to about 0.3.

10. The composition of claim 9 wherein the ratio of total lysine to protein is from about 0.06 to about 0.3.

11. The composition of claim 5 any wherein the ratio of total tryptophan to protein is from about 0.007 to about 0.015.

12-18. (canceled)

19. A process for preparing an extracted high lysine corn fraction from high lysine corn kernels, the process comprising (i) fractionating corn kernels comprising protein, oil and from about 3,000 parts per million to about 8,000 parts per million total lysine on an anhydrous basis into a high lysine fraction and a low lysine fraction, the high lysine fraction having a lysine content greater than the corn kernels and the low lysine fraction having an lysine content less than the corn kernels (ii) separating the high lysine fraction from the low lysine fraction, (iii) heat and pressure treating the high lysine fraction with steam in an expander to produce expandettes, and (iv) extracting oil from the expandettes with at least one solvent to prepare the extracted high lysine corn fraction.

20-24. (canceled)

25. The process of claim 19 wherein the expander temperature is from about 140° C. to about 165° C.

26. (canceled)

27. The process of claim 19 wherein the residence time for the high lysine fraction at the expander temperature is from about 0.5 to about 10 seconds.

28. The process of claim 19 wherein at least 85% of the total lysine contained in the high lysine corn kernels is recovered in the sum of the low lysine fraction and extracted high lysine corn fraction.

29. An extracted high lysine corn fraction prepared by the process of claim 19.

30. A method for formulating an animal food ration, the method comprising (i) determining the lysine requirements of the animal, (ii) identifying a plurality of natural and/or synthetic feed ingredients and the available total lysine of each of the ingredients wherein one of the ingredients is a corn portion having a total lysine concentration of from 0.6 to about 2.8 percent by weight on an anhydrous basis, and (iii) formulating the ration from the identified ingredients to meet the determined lysine requirement of the animal.

31. The method of claim 30 wherein the total lysine concentration in the corn portion is from about 0.8 to about 2.8 weight percent.

32. The method of claim 30 wherein the corn portion further comprises from about 0.06 to about 0.22 percent by weight total tryptophan on an anhydrous basis.

33-34. (canceled)

35. The method of claim 30 wherein the corn portion further comprises oil and the corn portion is a high lysine fraction prepared by fractionating corn kernels into a high lysine fraction and a low lysine fraction, the high lysine fraction comprising from about 8 to about 25 percent by weight oil on an anhydrous basis.

36. The method of claim 35 wherein the corn portion is an expanded high lysine fraction.

37. The method of claim 36 wherein the corn portion is a solvent extracted, expanded high lysine fraction.

38. (canceled)

39. The method of claim 37 wherein the corn portion has a ratio of total lysine to protein of from about 0.03 to about 0.3.

40. The method of claim 32 wherein the corn portion has a ratio of total tryptophan to protein of from about 0.007 to about 0.015.

41. The method of claim 30 wherein the lysine requirement of the animal is about 8 grams of lysine per kilogram of animal food ration and the corn portion contains at least 8 grams of lysine per kilogram of corn portion.

42. (canceled)
